(19) United States
(12) Patent Application Publication
(10) Pub. No.: US 2024/0131552 A1
(43) Pub. Date: Apr. 25, 2024

(54) HYBRID PAINT, DRYWALL COMPOUND, AND TEXTURE APPLICATOR SYSTEM

(71) Applicant: Uvaldo Vera Martin, Salem, OR (US)

(72) Inventor: Uvaldo Vera Martin, Salem, OR (US)

(21) Appl. No.: 18/492,562

(22) Filed: Oct. 22, 2023

Related U.S. Application Data
(60) Provisional application No. 63/418,889, filed on Oct. 24, 2022.

(51) Int. Cl. B05C 11/10; B05C 1/08; B05C 1/10; B05C 5/02; B05C 11/02

(52) U.S. Cl. CPC B05C 11/1036; B05C 1/0808; B05C 1/0813; B05C 1/10; B05C 5/02; B05C 11/023

(57) ABSTRACT

Portable hybrid system for application of any material of drywall compound material, paint material, and texture material by the hybrid system via any of a plurality of material expulsion outlet ports, comprising: a pressurizable hollow tank for carrying material, at least one air compressor for pressurizing the material from the tank, an optionally attachable paint roller subsystem, an optionally attachable paint sprayer subsystem, an optionally attachable drywall compound applicator subsystem, an optionally attachable texture applicator subsystem, and an optionally attachable edge-cutting porous paint pad subsystem, enabling a plurality of workers to apply a given material from a single tank of the material.

### CONTINUITY AND CLAIM OF PRIORITY

The present patent application claims the priority and benefit of U.S. Provisional Patent Application Ser. No. 63/418,889, filed Oct. 24, 2022.

### FIELD

The present invention relates to a portable, stable flow, hybrid applicator system, and more particularly to a hybrid system that allows persons to work simultaneously on a single job or even to apply different mediums using the same powered applicator to increase efficiency when doing home remodeling.

### BACKGROUND

Using separate tools to apply different materials such as paint, dry wall compound, or texture have been known in the prior art. Carrying around multiple tools from one location to another has been cumbersome and time consuming. Using separate tools has also been costly and inefficient. Combining various systems would be desirable to decrease cost and increase efficiency.

### I. Paint Roller System

Using a roller system comprising an absorbent sleeve on a cylindrical body rotatably mounted on a tubular or wire handle, to paint larger surfaces is known in the prior art, and using an extended pole to further facilitate doing so is likewise known in the prior art. With such long-handled systems, users have been enabled in more quickly painting even tall walls traditionally out of reach of the user without the use of a stepladder. However, such systems have been somewhat cumbersome, since users have had to very frequently re-dip, or re-roll, the roller, traditionally in a pan of paint to coat the absorbent roller sleeve, to make sure there has been an adequate supply of paint on the roller sleeve in order to adequately cover by rolling the roller sleeve along the surface to be painted.

To facilitate roller painting systems generally, there has been developed in the prior art a system for more continuously supplying paint from a reservoir through a handle to a roller using pressurized air, as taught in U.S. Pat. No. 2,751,618, to Pruitt. With Pruitt the paint had been supplied through the handle and through perforations in a hollow supply tubing armature located underneath the roller that had been rotatably carried on the hollow supply tubing. Thus, as pressurized air forced paint through the perforations into a cavity formed by the roller and end caps around the supply tubing, the roller material became saturated enabling more continuous applying paint coming through the roller and onto a surface. Since Pruitt taught the use of compressed air, requiring a larger compressor and pressurized air lines, it has been considered less portable.

To address the issue of lack of portability in such a more continuously-fed paint roller system, there has been developed in the prior art a system of more continuously supplying paint to a roller via a curved tubular conduit communicating via a valve assembly with a paint handle-contained reservoir having a paint pushing piston rod therein, as taught in U.S. Pat. No. 3,702,739, to Rentfrow. With Rentfrow, the user is enabled in portable, semi-continuously-fed rolling with a portable roller painting system, since it supplied a manually actuated plunger to force paint from the reservoir handle into an interior portion of the roller via perforations in the tubular conduit underneath the roller. Like Pruitt, the paint was then allowed to be absorbed into the sleeve of the roller for semi-continuous application of paint to the surface via the roller, semi-continuous in the sense that the user had to manually actuate the plunger to get more paint onto the roller, semi-continuous in the sense that the user had to use both hands to activate the manually-activated plunger to push more paint into the roller, and semi-continuous in the sense that the user had to frequently fill the handle over and over, thus necessitating downtime, before additional use was possible. To the extent that Rentfrow contemplated the use of an air compressor, i.e., with a pressurized hose attached, it has also been considered less portable.

These advancements in the prior art enabled the convenience of supplying additional paint at least more continuously, or semi-continuously, to the roller while the roller has been in use, thus facilitating somewhat more efficient painting. However, these advancements were limited in the sense that they were less portable, in the case of needed compressed air delivered by an air hose, or they provided less continuous painting in the case of the handle-reservoir system of Rentfrow, since there was a lesser amount of paint that could be contained in the limited length of the handle, and the user was required to use both hands to activate the plunger to push more paint into the roller. This latter fact contributed to the lesser suitability of a portable solution such as Rentfrow for larger paint jobs, and the need for two hands to press paint into the roller rendered Rentfrow less suitable for continuous painting, because the user was too busy trying to press paint into the roller with the plunger to focus on painting with a free hand. These facts further exacerbated the fact that filling the handle of Rentfrow had been cumbersome and got in the way of more continuous painting.

To deal with difficulties associated with filling the handle reservoir, in U.S. Pat. No. 7,556,447, to Bruggeman et al., there was provided a fill tube for more easily drawing paint from a paint can up into the tube of a handle reservoir supplied paint roller. Further, Bruggeman et al. taught a helical groove on the plunger for forcing paint retained in the handle reservoir into the paint roller. Nevertheless, the Bruggeman device was still somewhat limited in capacity by the length of the handle, and this led to additional effort, as with the Rentfrow device, requiring more frequent refilling of the handle reservoir. Further, like the Rentfrow device, Bruggeman et al. also required both hands to force more paint into the roller—an action that was not conducive to more continuously effortless rolling of paint onto the surface. Further, Bruggeman clearly was not well-suited for larger paint jobs because of the frequent need for refilling of the reservoir.

Addressing the lack of portability in the Pruitt prior art roller system, and to allow supply of somewhat more paint than was feasible with the Rentfrow system, there has been developed a Weathershield backpack paint roller system by Dulux. The Dulux system allows for portable carrying of a specially-designed paint pack in the backpack, and the user is enabled in attaching a power unit to the specially-designed paint pack, together with a dip tube, for trigger-fed power assisted drawing of paint into a flexible hose for supplying paint to the roller. Thus, the Dulux system provided somewhat more continuous painting capability than Rentfrow, but the Dulux system only provided about a gallon of paint, at the most, and there was also the drawback that the Dulux system required a special, smaller, paint pack, requiring more frequent changes and less convenient use of only certain types of paint available in such a pack. Or, alternatively, the user has been required to re-fill the special pack more often because it is a smaller form factor. Thus, the Dulux system was also been somewhat limited in being able to provide more continuously-fed paint to a roller for larger, for example commercial, paint jobs.

The Dulux system provided an optional extension pole for attaching to the roller for harder-to-reach places. However, it was still advertised with the use of a ladder, it being the case that the Dulux system also provides for hands-available climbing of the ladder with a roller holder accessory to be located on the front of the backpack near the chest of the user. For these reasons, i.e., the need for a lower-capacity special paint pack, and an apparently more suitable shorter handle, the Dulux system is not considered to be ideally suited for larger commercial jobs.

Responsive to the foregoing shortcomings of the prior art, the Applicant hereof filed U.S. patent application Ser. No. 17/301,287 for Paint Roller System, wherein there is provided an enlarged paint-holding tank as part of an optional backpack, a longer handle for a paint roller, and both a manual and an air-compressor pressurization capability, all capable of being easily manufactured out of readily available components.

### II. Paint Sprayer

Using a paint sprayer, airless and non-airless, to apply paint to an object is known in the prior art. Paint is applied evenly to a surface through use of an air pressurized spray gun or through a high-pressure pump to stabilize continuous flow. With such, users have been enabled to quickly paint various types of objects, such as walls, without the use of applying paint through a brush or paint roller.

However, there have not been known in the prior art a single machine that would have allowed both powered painting with a roller and powered painting with a roller, and such a machine would be desirable, both from an efficiency standpoint and a cost standpoint.

### III. Edge-Cutting Porous Paint Pad

Using a paint pad, often comprised of a spongy material with short, densely-packed, bristles, or fibrils, extending therefrom on a wall facing surface and mounted on a frame extending from a handle, or even extending from an extended pole, to facilitate painting walls is known in the prior art. With such, such as that found at HOMERIGHT® P/N C800249, for Replacement Paint Pivot Pad, users have been enabled in more quickly painting various types of walls, whether easily within reach, or whether traditionally out of reach, of the user without the use of a stepladder.

Further, such paint pads have been employed with powered paint supply systems, as described in U.S. Pat. No. 5,454,656, to Rowe, for Paint Pad Assemblies with a Pump Supplied Reservoir, and further as shown at HOMERIGHT® P/N C800250, for Paint Pivot Pad, thus avoiding the otherwise cumbersome process of having to have very frequently re-dipped the pad in a pan of paint to coat the paint pad, to make sure there has been an adequate supply of paint on the pad in order to have adequately covered a surface by dragging the paint pad along the surface to be painted. And thus, the desirability of a more continuously-fed paint pad system had become apparent, since with such a system the user hasn't had to continually re-dip the pad in a pan of paint.

There have been provided various multi-laterally deflecting, or flexible, paint pad interconnection systems, where a handle, attachable to an extensible pole, may have been able to be deflected by a user in two, or more different directions relative to the paint pad using a multi-direction deflection mechanism. This has allowed flexibility in wielding the handle or pole, while allowing the paint pad to stay readily in contact with the wall, or other surface, to be painted. And while such have also been included with a powered paint supply reservoir as previously described, such have not included a paint pad edger on a powered paint supply system such as a powered backpack system with, or without, a larger capacity supply.

There have been provided various other paint pad trim tools, such as the Mr. Long Arm Trim Smart Paint Edger. This has included a paint pad on a frame mounted to a handle to which a longer pole has been mounted. And while this edger has provided wheels, or rollers, on the frame to keep the pad distanced from a surface, such as a ceiling, which was not to have been painted, while allowing painting an adjacent surface, this has not included such a paint pad edger on a powered paint supply system such as a powered backpack system with a larger capacity supply.

Another powered paint supply system providing for supplying paint to a paint pad is found in U.S. Pat. No. 4,611,941, to Karliner et al., for Pressurized Paint Pad Mounting.

To facilitate painting systems generally, there has been developed in the prior art a system for more continuously supplying paint from a reservoir through a handle, typically to a roller, using pressurized air such as has been provided by a Weathershield backpack paint roller system by Dulux. The Dulux system allows for portable carrying of a paint pack in the backpack, and the user has been enabled in attaching a power unit to the specially-designed paint pack, together with a dip tube, for trigger-fed power assisted drawing of paint into a flexible hose for supplying paint to a roller. Thus, the Dulux system, and the other aforementioned systems, provided somewhat continuous painting capability, but these systems only provided about a gallon of paint for a backpack-type system, at the most, and there was also the drawback that the Dulux system required a special, smaller, paint pack, requiring more frequent changes and less convenient use of only certain types of paint available in such a pack. Or, alternatively, the user has been required to re-fill the special pack more often owing to the fact that it is a smaller form factor. Thus, the Dulux system was also been somewhat limited in being able to provide more continuously-fed paint to a roller for larger, for example commercial, paint jobs.

Another powered paint supply system has been the Wagner Spraytech powered roller system, and while it has provided for a powered system from a larger paint supply (e.g., 5-gallon paint bucket sitting on the floor), this has not taught such a larger paint supply for a backpack system.

But, there has been needed both a paint roller and preferably interchangeable paint pad edger tool adapted to a powered paint supply system and adapted to also be used as a sprayer, preferably connected to a paint supply system that is portable, such as capable of being carried on a backpack, and further preferably on such a portable paint supply system that is more suitable for larger commercial jobs since it enables the user to carry significantly more than just a gallon of paint to enable more continuous supply of paint to the roller, the paint pad, and the sprayer. Such a system would preferably be easy to fill, easy to clean, and in an embodiment able to be constructed relatively easily of otherwise readily available components, whereas further the system would preferably be able to provide a paint pad applicator, a paint roller applicator, and a paint sprayer, all capable of being powered with the same powered paint supply system.

### IV. Dry Wall Compound Applicator System

Using a dry wall compound applicator system, comprising a fillable tube with one end attached to a funnel with a tip for dispensing dry wall compound and another end attached to a plunger for creating vacuum suction when pulled along the length of the tube to fill the tube and for pushing along the length of the tube to create pressure to dispense and apply dry wall compound to a wall or a corner of walls is known in the prior art. Further, using an applicator attached to the tip of the funnel to further facilitate doing so is likewise known in the prior art, such as is provided by Can-AM Tool Corporation's A100 Compound Tube. Can-AM's Compound Tube is comprised of a fillable tube with a funnel with a rounded tip for attaching various applicators attached at one end and a plunger for sucking in and dispensing the dry wall compounds at the other end. Among Can-AM's applicators are a Flat Applicator, a 2-Wheel Inside Corner Applicator, a GoldCor Inside Corner Applicator, a Bead Applicator, a Roller Glide Corner Finisher, a Standard Corner Finisher, a Direct Roller Glide Corner Finisher, a Direct Corner Finisher, an Accu-Just Corner Finisher, a Direct Accu-Just Corner Finisher, a Creaser Corner Finisher, and a NyCor Finisher.

To fill a fillable portion of dry wall compound applicator systems generally, there has been developed in the prior art a hand pump system for manually pumping dry wall compound into a fillable portion of dry wall compound applicator systems, such as a compound pump sold by LEVEL5 Tools, LLC for use with an automatic taper system. LEVEL5's compound pump is a pump system comprising a goose neck pipe, a pump handle, and a rubber seal gasket. With this system, a portion of a pump body is placed into a container with dry wall compound and the pump handle is used to pump the dry wall through the goose neck pipe and into the dry wall compound applicator system. Thus, a user must use the pump handle to create pressure to force the dry wall compound to fill the dry wall compound applicator system for use.

With such hand powered plunging dry wall compound applicator systems, users have been enabled to fill, dispense, and apply dry wall compound to a surface of a wall or a corner of the walls more quickly. However, such systems have been somewhat cumbersome, since users have had to manually with their hands and arms push the plunger into the tube to dispense dry wall compound from the tip of the funnel, causing inconsistent flow depending on the pressure the user is applying and therefore inconsistent application of the dry wall compound. It has been somewhat difficult to put consistent pressure as the user applies the dry wall compound from one end of the wall to another and as the dry wall compound applicator system moves against the wall. And thus, the desirability of a more stable flow dry wall compound applicator system had become apparent.

Various caulk guns and adhesive guns with trigger handles are known in the art. There exists hand powered as well as electric powered caulk guns and adhesive guns. Electric powered caulk and adhesive guns known in the art include Milwaukee M18 18-Volt Lithium-Ion Cordless 10 oz. Caulk and Adhesive Gun and DEWALT 20-Volt MAX Cordless 300-600 mL Sausage Pack Adhesive Gun, which use electric power to push the plunger in constant rate for constant flow. Caulk guns which comprise a handle with a trigger adapted for use with an electrified air compressor and that when triggered push a plunger against the back of a tube of material to push the material out of the tube at a constant flow, are also known in the art, such as Campbell Hausfeld Air Powered Caulk Gun and Chicago Pneumatic CP9885 Air Caulking Gun.

To evenly apply dry wall compound, a scraper, joint knife, or putty knife, with a handle has been used and is known in the art. However, the ones used in the art are typically a separate tool from a dry wall applicator system, they have been ridged edged, and a user must stop the process of applying the dry wall compound with an applicator system to switch to the knife to even out the dry wall compound applied, which has been cumbersome and time consuming to do. Carrying around multiple tools from one area of the job site to the next, and from one job site to another, has also been cumbersome as well. Further, the knife-edged portion of the tool usually comprises one elongated side of the tool head, making it not as easy to use for non-flat spaces such as a corner. Thus, there has been needed an improved portable, stable flow, dry wall compound applicator system that evenly applies dry wall compound to a wall or a corner of the walls. Such a system will preferably be easy to fill, easy to clean, and in an embodiment able to be constructed relatively easily of otherwise readily available components.

Further, it would be preferable if a single machine could be devised to allow powered application of both paint (whether through a roller, a paint pad, or a sprayer) and drywall compound—though at different times as to painting versus application of drywall compound.

### V. Air Compressor

Using electric motors or gasoline motors to create pressure to different application systems, such as paint roll systems or dry wall compound applicator system, for continuous flow and application of materials is known in the prior art. These air pressure compressors create continuous flow to ensure materials are able to be applied to various surfaces. While air pressure compressors allowed material to quickly be applied, only one application system could be used with the air pressure compressors. The different application systems could not be used together and still had to be used separately for different uses.

### VI. Spray Texture Applicator

Using compressed air for forcing a spray texture medium out of a nozzle of a texture gun for purposes of texturing walls before painting is known in the prior art. However, prior such guns have been bulky and heavy in part, in some cases, because some have included on top of the gun a hopper that holds the spray texture medium. It would be beneficial if, as part of a Hybrid system, spray texture could be supplied via a hose to a standard spray texture gun.

### SUMMARY

In accordance with an aspect and embodiment of the disclosure, there is provided a portable, stable flow, multi-use, hybrid system for application of any material of drywall compound material, paint material, and texture material by the hybrid system. The system comprises: a pressurizable hollow tank having a sealable, openable opening adapted for insertion of material comprised of any one of drywall compound, paint, and texture compound. The tank further comprises a first outlet port for pressurized expulsion of the material being used at a given time, the tank further communicating with at least one other outlet port for simultaneous expulsion of material being used at the given time via the at least one other outlet port.

The hybrid system further comprises an air compressor adapted for pressurizing at least a portion of the material supplied from the tank at a given time, and one or more of the following:
a. Optionally attachable/detachable (easily optionally attachable/detachable) at least one paint roller subsystem optionally detachably attachable to one of the first outlet port and the another outlet port, adapted for pressurized application of paint supplied from the tank to a surface via a roller;
b. At least one paint sprayer subsystem optionally detachably attachable (easily optionally attachable/detachable) to one of the first outlet port and the another outlet port, adapted for pressurized application of paint from the tank to a surface via a sprayer;
c. At least one drywall compound applicator subsystem optionally detachably attachable (easily optionally attachable/detachable) to one of the first outlet port and the another outlet port, adapted for pressurized application of drywall compound from the tank to a surface via a drywall compound applicator;
d. At least one texture applicator subsystem optionally detachably attachable (easily optionally attachable/detachable) to one of the first outlet port and the another outlet port, adapted for pressurized application of texture compound to a surface via texture applicator; and
e. An edge-cutting porous paint pad subsystem optionally detachably attachable (easily optionally attachable/detachable) to one of the first outlet port and the another outlet port, adapted for pressurized application of paint to a surface via an edge-cutting porous paint pad.

In accordance with this aspect and embodiment of the disclosure, the hybrid system's second outlet port is adapted for simultaneous use of the system by a plurality of users, such that the plurality of users may simultaneously use the system to apply one of drywall compound, paint, and texture, whichever material happens to be loaded into the tank at a given time. Then, preferably after cleaning the tank, at another time the system may be loaded with another one of drywall compound, paint, and texture, the system is likewise capable of supplying such another one of material to a plurality of users, and depending upon which of the paint roll subsystem, the paint sprayer subsystem, the drywall compound applicator subsystem, the texture applicator subsystem, and the edge-cutting porous paint pad subsystem is optionally detachably attached to the tank. Thus, the system is adapted for facilitating application of these different materials, all without any adjustment required to the tank, pressurization system, or hoses designed to carry material from the tank to the various applicators described herein.

Thus, the hybrid system is capable of use for painting, for example, where one user may use one of the paint roller subsystem, the paint sprayer subsystem, and the edge-cutting porous paint pad subsystem, simultaneously while another user may use another of the paint roller subsystem, the paint sprayer subsystem, and the edge-cutting porous paint pad subsystem. Further, the paint roller subsystem may be supplied with an attachable and detachable enlarged paint roller.

Thus, in a preferred embodiment of this aspect of the disclosure, the hybrid system is provided wherein the paint roller subsystem comprises a pole with a paint roller attached to an end of the pole, for allowing application of paint via a flexible hose interconnecting the paint roller and pressurized paint from the tank, and wherein the paint roller subsystem further comprises a trigger for independently controlling flow of paint through the paint roller subsystem.

Further, in this preferred embodiment of this aspect of the disclosure, the hybrid system is provided wherein the paint sprayer subsystem comprises a paint spray gun for allowing application of paint via a flexible hose interconnecting the paint spray gun and pressurized paint from the tank, and wherein the paint sprayer subsystem further comprises a trigger for independently controlling flow of paint through the paint sprayer subsystem.

Still further, in accordance with this embodiment of this aspect of the disclosure, there is provided the hybrid system wherein the edge-cutting porous paint pad subsystem comprises a pole with an edge-cutting porous paint pad attached to an end of the pole, for allowing application of paint via a flexible hose interconnecting the edge-cutting porous paint pad and pressurized paint from the tank, and wherein the edge-cutting porous paint pad subsystem further comprises a trigger for independently controlling flow of paint through the edge-cutting porous paint-pad subsystem. The edge-cutting porous paint pad preferably comprises a cutting edge adapted for facilitating painting straight edges.

Yet further, in accordance with this aspect and embodiment of the disclosure, the hybrid system is provided wherein the drywall compound applicator subsystem further comprises a pole with a drywall compound applicator attached to an end of the pole, for allowing application of drywall compound via a flexible hose interconnecting the drywall compound applicator and pressurized drywall compound from the tank, and wherein the drywall compound applicator subsystem further comprises a trigger for independently controlling flow of drywall compound through the drywall compound applicator subsystem. Preferably, the drywall compound applicator further comprises a squeegee attached with at least one edge adapted for use on one of corners or a flat surface.

Further, in accordance with this aspect and embodiment of the disclosure, there is provided a hybrid system, wherein the texture applicator subsystem further comprises a texture spray applicator, or gun, for allowing application of spray texture via a flexible hose interconnecting the texture spray gun and pressurized texture compound from the tank, and wherein the texture applicator subsystem further comprises a trigger for independently controlling flow of texture compound through the texture applicator subsystem.

In accordance with an aspect and embodiment of the disclosure, the hybrid system tank further comprises straps and a waist belt for attaching the tank as a backpack to a user's back, to facilitate portability of the system. The hybrid system in accordance with an aspect and embodiment of the disclosure however also comprises a frame stand for enabling it to stand upright on its own on a floor, for example in the middle of a room to be painted.

In accordance with another aspect and embodiment of the disclosure, there is provided a portable, stable flow, multi-use, hybrid system for application of any material of drywall compound material, paint material, and texture material by the hybrid system, comprising: a pressurizable hollow tank having a sealable, openable opening adapted for insertion of material comprised of any one of drywall compound, paint, and texture compound, the tank further comprising a first outlet port for pressurized expulsion of the material being used at a given time, the tank further communicating with at least one other outlet port for simultaneous expulsion of material being used at the given time via the at least one other outlet port.

In accordance with this aspect and embodiment, the hybrid system is provided with a manual pump air compressor adapted for pressurizing at least a portion of the material supplied from the tank at a given time, and there is further provided a diaphragm pump (driven by compressed air from an air compressor) attached to the tank adapted for providing simultaneous expulsion of material being used at a given time in the tank via the at least one other outlet port. Thus, the hybrid system of this embodiment and aspect further comprises an electric air compressor adapted for pressurizing at least another portion of the material supplied from the tank at a given time.

The hybrid system of this aspect and embodiment of the disclosure thus further comprises an electric air compressor adapted for pressurizing at least a portion of the material supplied from the tank at a given time, and one or more of the following:
a. optionally attachable/detachable (easily optionally attachable/detachable) at least one paint roller subsystem optionally detachably attachable to one of the first outlet port and the another outlet port, adapted for pressurized application of paint supplied from the tank to a surface via a roller;
b. At least one paint sprayer subsystem optionally detachably attachable (easily optionally attachable/detachable) to one of the first outlet port and the another outlet port, adapted for pressurized application of paint from the tank to a surface via a sprayer;
c. At least one drywall compound applicator subsystem optionally detachably attachable (easily optionally attachable/detachable) to one of the first outlet port and the another outlet port, adapted for pressurized application of drywall compound from the tank to a surface via a drywall compound applicator;
d. At least one texture applicator subsystem optionally detachably attachable (easily optionally attachable/detachable) to one of the first outlet port and the another outlet port, adapted for pressurized application of texture compound to a surface via texture applicator; and
e. An edge-cutting porous paint pad subsystem optionally detachably attachable (easily optionally attachable/detachable) to one of the first outlet port and the another outlet port, adapted for pressurized application of paint to a surface via an edge-cutting porous paint pad.

In accordance with this aspect and embodiment of the disclosure, the hybrid system's second outlet port is further adapted for simultaneous use of the system by a plurality of users, such that the plurality of users may simultaneously use the system to apply one of drywall compound, paint, and texture, whichever material happens to be loaded into the tank at a given time. Then, preferably after cleaning the tank, at another time the system may be loaded with another one of drywall compound, paint, and texture, the system is likewise capable of supplying such another one of material to a plurality of users, and depending upon which of the paint roll subsystem, the paint sprayer subsystem, the drywall compound applicator subsystem, the texture applicator subsystem, and the edge-cutting porous paint pad subsystem is optionally detachably attached to the tank. Thus, the system is adapted for facilitating application of these different materials, all without any adjustment required to the tank, pressurization system, or hoses designed to carry material from the tank to the various applicators described herein. This is enabled because larger, e.g., standard garden, hoses may be used, together with standard attachment hardware, or even standard quick connect hardware, may be used with the system.

Thus, the hybrid system is capable of use for painting, for example, where one user may use one of the paint roller subsystem, the paint sprayer subsystem, and the edge-cutting porous paint pad subsystem, simultaneously while another user may use another of the paint roller subsystem, the paint sprayer subsystem, and the edge-cutting porous paint pad subsystem. Further, the paint roller subsystem may be supplied with an attachable and detachable enlarged paint roller.

Thus, in a preferred embodiment of this aspect of the disclosure, the hybrid system is provided wherein the paint roller subsystem comprises a pole with a paint roller attached to an end of the pole, for allowing application of paint via a flexible hose interconnecting the paint roller and pressurized paint from the tank, and wherein the paint roller subsystem further comprises a trigger for independently controlling flow of paint through the paint roller subsystem.

Further, in this preferred embodiment of this aspect of the disclosure, the hybrid system is provided wherein the paint sprayer subsystem comprises a paint spray gun for allowing application of paint via a flexible hose interconnecting the paint spray gun and pressurized paint from the tank, and wherein the paint sprayer subsystem further comprises a trigger for independently controlling flow of paint through the paint sprayer subsystem. In this way one user may be spraying, while another user may be simultaneously backrolling, or using the paid pad applicator, all using the same system and container. Such provides a great improvement of productivity in any paint job, and especially larger (e.g., commercial) paint jobs.

Still further, in accordance with this embodiment of this aspect of the disclosure, there is provided the hybrid system wherein the edge-cutting porous paint pad subsystem comprises a pole with an edge-cutting porous paint pad attached to an end of the pole, for allowing application of paint via a flexible hose interconnecting the edge-cutting porous paint pad and pressurized paint from the tank, and wherein the edge-cutting porous paint pad subsystem further comprises a trigger for independently controlling flow of paint through the edge-cutting porous paint-pad subsystem. The edge-cutting porous paint pad preferably comprises a cutting edge adapted for facilitating painting straight edges.

Yet further, in accordance with this aspect and embodiment of the disclosure, the hybrid system is provided wherein the drywall compound applicator subsystem further comprises a pole with a drywall compound applicator attached to an end of the pole, for allowing application of drywall compound via a flexible hose interconnecting the drywall compound applicator and pressurized drywall compound from the tank, and wherein the drywall compound applicator subsystem further comprises a trigger for independently controlling flow of drywall compound through the drywall compound applicator subsystem. Preferably, the drywall compound applicator further comprises a squeegee attached with at least one edge adapted for use on one of corners or a flat surface. Thus, users may be enabled in having a single system that enables both paint application, as well as drywall compound application, and of course this greatly reduces the expense otherwise needed for dual systems.

Further, in accordance with this aspect and embodiment of the disclosure, there is provided a hybrid system, wherein the texture applicator subsystem further comprises a texture spray applicator, or gun, for allowing application of spray texture via a flexible hose interconnecting the texture spray gun and pressurized texture compound from the tank, and wherein the texture applicator subsystem further comprises a trigger for independently controlling flow of texture compound through the texture applicator subsystem. So, yet further, this means that the same machine (after being cleaned for example) may be used for all three applications: painting, drywall compound application, and spray texture application. This in turn saves room in a commercial contractor's vehicle used to transport equipment to and from job sites.

The hybrid applicator system in accordance with the foregoing aspects and embodiments addresses the shortcomings of the prior art systems, providing a way to combine the multiple tools into one system with stable air flow provided by the electrified air compressor for a user to evenly apply materials such as paint, dry wall compound, or texture. Further, the system allows simultaneous application by two separate users of whichever material happens to be in the tank, whether paint, drywall compound, or texture material.

### BRIEF DESCRIPTIONS OF DRAWINGS

FIG. 1 is a front perspective view of the hybrid system combining the paint roll system, edge-cutting porous paint pad, sprayer (whether a paint or a texture sprayer), and the dry wall compound applicator system in accordance with an aspect and embodiment of the disclosure;

FIG. 2 is a side perspective view of a tank portion, a pressurized manifold portion, and two interconnecting hoses and poles of the hybrid system of FIG. 1;

FIG. 3 is another side perspective of roller pole and paint pad pole portions (i.e., subsystems), together with of the hybrid system shown in FIG. 2;

FIG. 4 is back perspective view of backpack container, manifold, pump handle, hoses, and paint roller and paint pad portions (subsystems) of the hybrid system of FIGS. 1 and 2;

FIG. 5 is a top perspective view of backpack container, pressurized manifold and connection hose, and outlet paint/drywall/texture hoses of the hybrid system of FIGS. 1 and 2;

FIG. 6 is an angled front perspective view of the paint pad and sprayer (texture or paint) portions (subsystems) of an example embodiment of a portion of the hybrid system;

FIG. 7 is a angled front perspective view of another example embodiment of a portion of the hybrid system comprising the attachable paint roller system and edge-cutting porous paint pad, both embodied in a system wherein two users may use each of these simultaneously, one through one hose and one through another hose connected to the manifold of the hybrid system, in accordance with an aspect and embodiment of the disclosure;

FIG. 8 is a front perspective of an example embodiment of a larger-scale paint roller brush, with dual feed lines, and that may be used with a paint roller system of the hybrid system, in accordance with an aspect of the disclosure;

FIG. 9 is a front perspective view of an example embodiment of the pole and roller of a portable, battery-powered, enhanced continuously-fed, hybrid paint roller, paint pad, drywall applicator, and texture (or other spray) applicator system (e.g., as shown in FIG. 1) in accordance with an aspect and embodiment of the disclosure;

FIG. 10 is a front perspective view of another example embodiment of a portable, manually-powered, enhanced continuously-fed, paint roller system adapted to be connected to the hybrid system hereof (e.g., as shown in FIG. 1), in accordance with an aspect of the disclosure;

FIG. 11 is a front perspective view of the roller, extendible pole, and paint supply portions of the paint roller system of FIG. 10 and adapted for use with the hybrid system hereof (e.g., as shown in FIG. 1);

FIG. 12 is a front perspective view of a hollow perforated roller frame member adapted for carrying a rotatable paint roller member thereon and for connection to an extensible/retractable paint roller handle adapted for use with the hybrid system hereof (e.g., as shown in FIG. 1);

FIG. 13 is a front perspective view of the hollow perforated roller frame member of FIG. 12, together with the rotatable roller member, an internal baffle for better control of paint once pumped into the roller; and end caps for sealing the ends of the rotatable roller member around the perforated roller frame member, these components being adapted for being connected to an extensible/retractable paint roller handle adapted for use with the hybrid system hereof (e.g., as shown in FIG. 1);

FIG. 14 is a close-up perspective view of a universal type, multi-angle, clamp for interconnecting the roller frame member of FIGS. 8-13 with an extensible/retractable handle adapted for being connected to an extensible/retractable paint roller handle adapted for use with the hybrid system hereof (e.g., as shown in FIG. 1);

FIG. 15 is a close-up perspective view of an example threaded coupling device and interconnection system combination for interconnecting the paint supply hose with the roller frame member at one end of the supply hose and the paint container at the other end of the supply hose;

FIG. 16 is a close-up perspective view of an example threaded coupling device and interconnection system combination, together with the threaded paint supply outlet for interconnecting the paint supply tube with the pressurized portion of the paint container;

FIG. 17 is a side perspective view of a dry wall compound applicator system in accordance with an aspect and embodiment of the disclosure adapted for being connected to a pressurized air source and for use together with the hybrid system hereof (e.g., as shown in FIG. 1);

FIG. 18 is a side perspective view of a funnel attached to a tube of the dry wall compound applicator system of FIG. 17 and adapted for funneling drywall compound from the tube, with assistance from pressurized air, in accordance with an aspect and embodiment of the disclosure;

FIG. 19 is a front perspective view of the funnel of a ball-shaped tip end of the funnel of the dry wall compound applicator system of FIGS. 17 and 18, showing its opening adapted for attachment to the drywall compound applicator head in accordance with an aspect and embodiment of the disclosure;

FIG. 20 is a rear perspective view of an inside portion of the funnel of FIGS. 18-19 adapted for attachment to the end of the drywall compound applicator tube in accordance with an aspect and embodiment of the disclosure, showing the inner circumference of the funnel and a mesh insert;

FIG. 21 is an angled side perspective view of how a diaphragm insert may be inserted into a first end of the tube of the drywall applicator tube, to facilitate the flow of drywall compound through the tube when the mud applicator system portion of the hybrid system is being used in accordance with an aspect and embodiment of the disclosure;

FIG. 22 is a side perspective view of the diaphragm insert of FIG. 21 in accordance with an aspect and embodiment of the disclosure;

FIG. 23 is a side perspective view of a pneumatic handle portion of the drywall applicator system and attached near a second end of the tube of the drywall applicator system of the hybrid system in accordance with an aspect and embodiment of the disclosure;

FIG. 24 is a side perspective view of an air flow hose portion of the drywall applicator system and attached to the pneumatic handle of FIG. 23 of the drywall applicator system of the hybrid system in accordance with an aspect and embodiment of the disclosure;

FIG. 25 is a top plan perspective view of a squeegee applicator of the drywall applicator system of the hybrid system and attached to a spring in accordance with an aspect and embodiment of the disclosure;

FIG. 26 is an angled perspective view of the applicator of FIG. 25 attached to the funnel of FIGS. 18-20, in accordance with an aspect and embodiment of the disclosure;

FIG. 27 is an angled perspective view of the applicator of FIGS. 25-26 and adapted for attachment to the funnel of FIGS. 18-20, in accordance with an aspect and embodiment of the disclosure;

FIG. 28 is a side perspective view of a different embodiment of an applicator for use in applying dry wall compound to corners between two walls and attached to the funnel of FIGS. 18-20 in accordance with an aspect and embodiment of the disclosure;

FIG. 29 is a bottom perspective view of the different embodiment of the applicator of FIG. 28 for use in applying dry wall compound to corners between two walls and attached to the funnel in FIGS. 18-20, in accordance with an aspect and embodiment of the disclosure;

FIG. 30 is a bottom front perspective view of a multi-direction deflection mechanism and edge spacer enabled paint pad combination, that is, an improved edge-cutting porous paint pad, attached to an elongated handle, adapted for receiving paint from the pressurized continuous-flow paint system of FIG. 1, and shown in a position of use above a door frame with the paint pad on the wall and an edge spacer in a corner between the ceiling and the wall, in accordance with an aspect and embodiment of the disclosure;

FIG. 31 is a bottom front perspective view of a multi-direction deflection mechanism and alternate, wheeled, edge spacer enabled paint pad combination, that is, an alternate embodiment improved edge-cutting porous paint pad, adapted for receiving paint from a pressurized continuous-flow paint system of FIGS. 1 and 4, in accordance with an aspect and embodiment of the disclosure;

FIG. 32 is a front perspective view of a portion of a multi-direction deflection mechanism edge spacer enabled paint pad combination, and adapted for receiving paint from a pressurized continuous-flow paint system of FIGS. 1 and 4;

FIG. 33 is a side perspective view of the multi-direction deflection mechanism edge spacer enabled paint pad combination of FIG. 32, and adapted for receiving paint from a pressurized continuous-flow paint system of FIGS. 1 and 4;

FIG. 34 is a front perspective view of an alternative embodiment electric powered paint hybrid applicator system (as an original equipment system and not as completely adapted from prior existing components), which allows simultaneous application of paint by two workers, whether power roller and/or power paint pad application;

FIG. 35 is another front perspective view of another alternative embodiment paint hybrid applicator system, similar to that of FIG. 34 (comprising an original equipment system and not as completely adapted from existing components) and further illustrating a charging plug and adapter for allowing charging of optional batteries of the system; and

FIG. 36 is a side perspective view of a texture applicator, or spray gun, adapted for use with a continuous supply of spray texture compound by way of an over-the-shoulder hose or tube that feeds into the inlet port of a more traditional texture applicator as supplied via the hybrid system of this disclosure.

### DETAILED DESCRIPTION

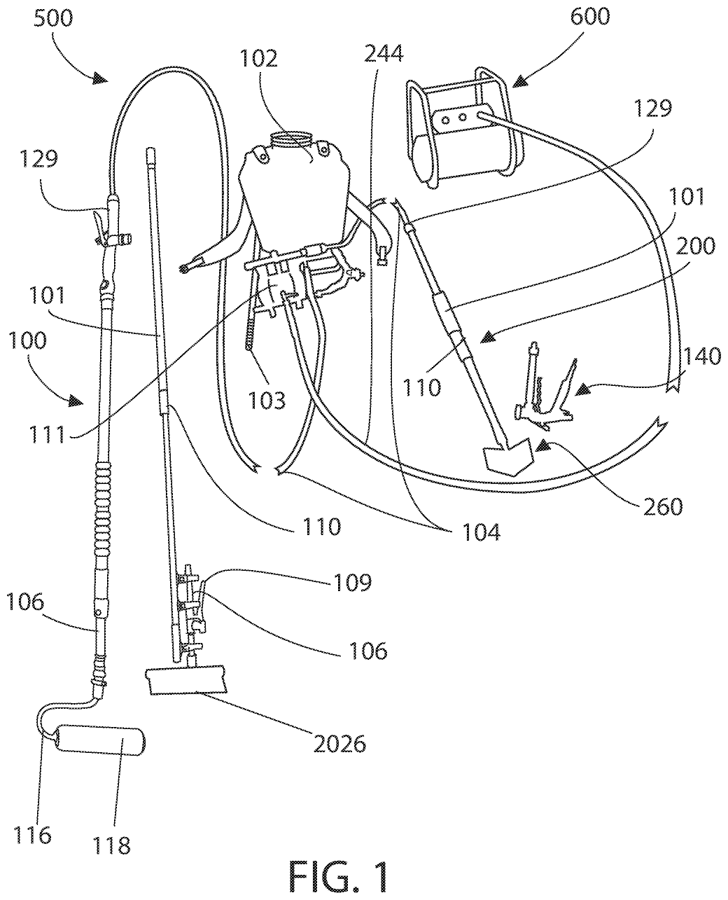

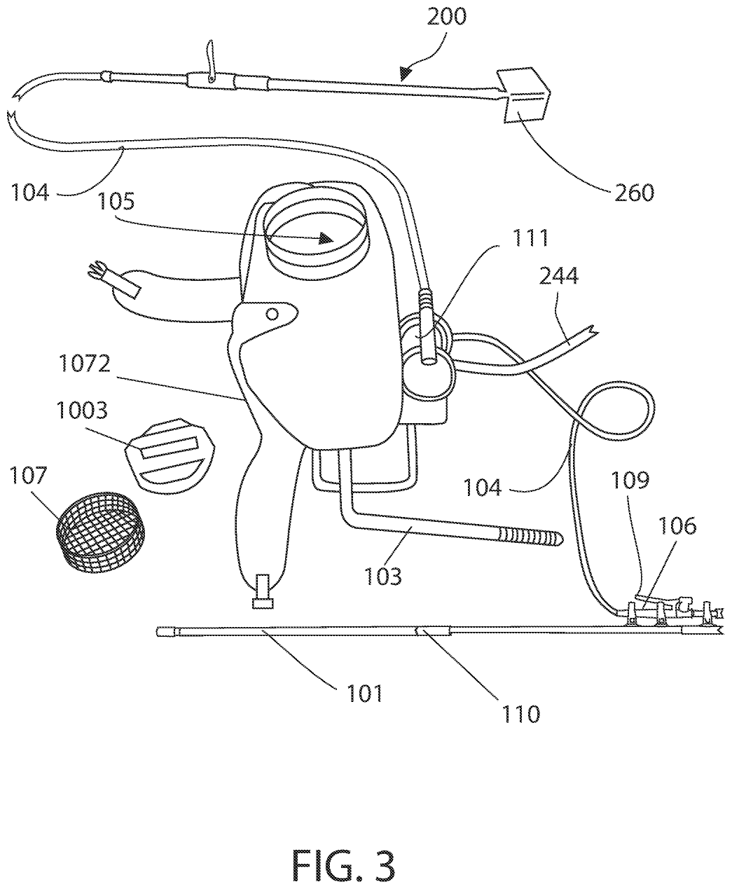

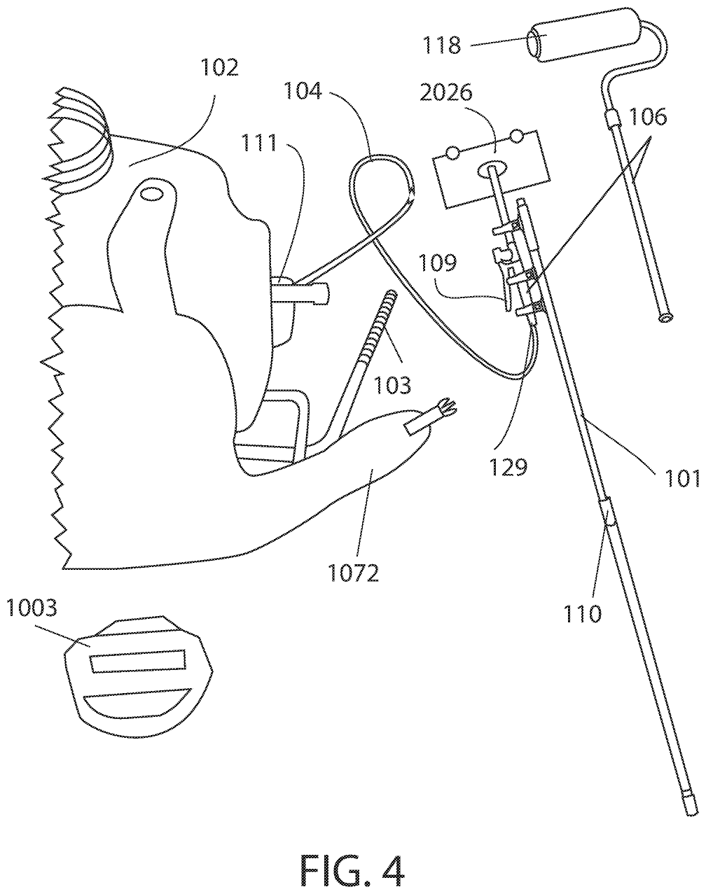

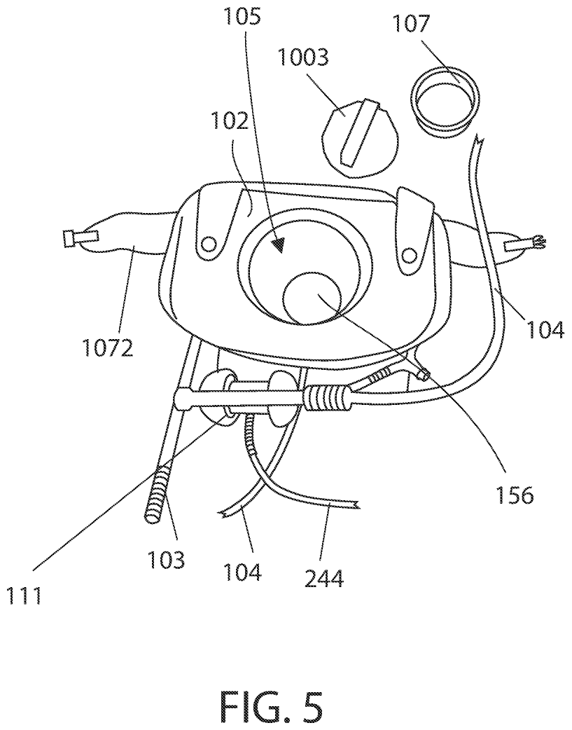

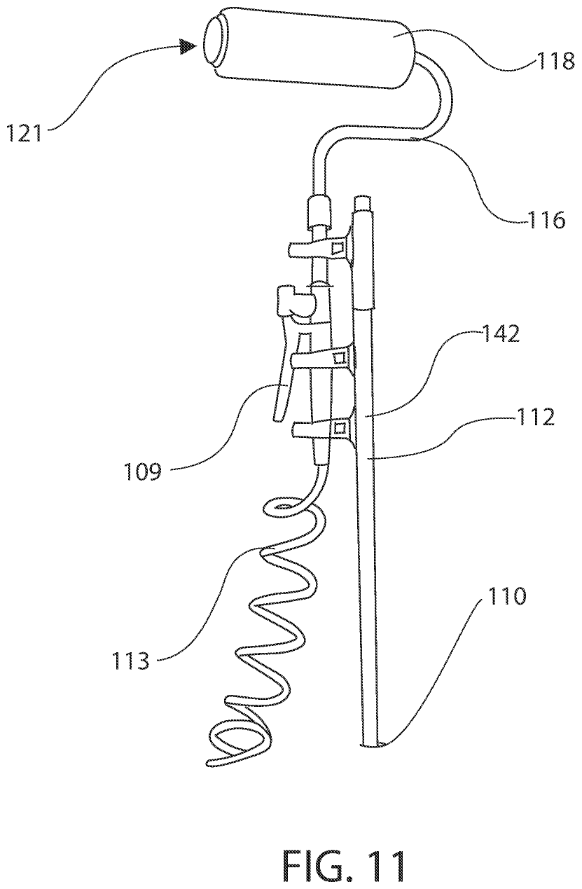

Referring to FIGS. 1-11, there is provided an embodiment of a hybrid paint roller, paint pad, drywall applicator, and sprayer (texture and paint) system 500 where multiple systems, such as the paint roller system 100 and dry wall compound applicator system 200, may be combined with an electric motorized air compressor 600 in accordance with one or more aspects of the disclosure. The hybrid system 500 comprises a container 102, capable of holding common latex or oil-based paint, dry wall compound, or spray texture material.

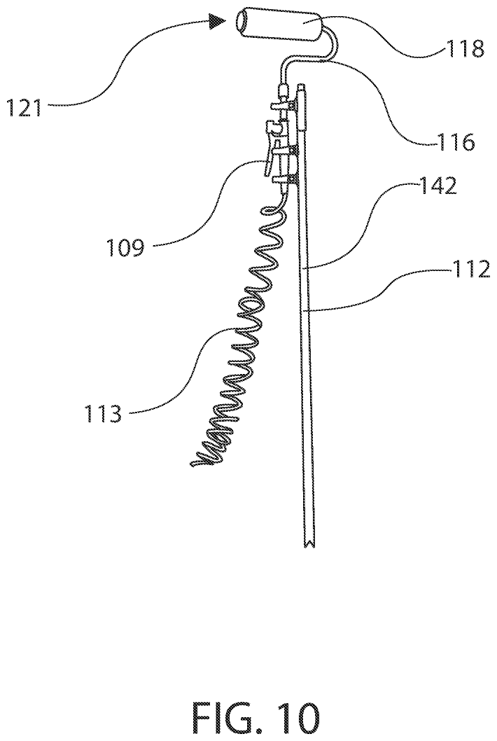

The container 102 comprises a twist-off cap 1003 covering and opening 105 for enabling filling of the container with paint, drywall compound, or texture material. There is also provided a filter device 107 that sits in the opening 105 under the cap 1003. The container 102 further comprises shoulder straps and waist belt 1072, enabling carrying of the container full of material as a backpack. The paint roller system 100 further comprises a longer handle 106 (between 1 and 3 meters) attached to a roller system 118, and which may be attached as with clamps or a bracket to a longer, optionally-extensible, handle 101. The longer handle 101 may comprise a twisted threaded release mechanism 110 (for example as shown in FIG. 10) for enabling extending and retracting of the handle 101 via telescoping means with one section 142 of the handle nested in another section 112 of the handle again as shown in FIG. 10. The extensible pole handle for the paint roller system may include an independently actuatable valve as shown.

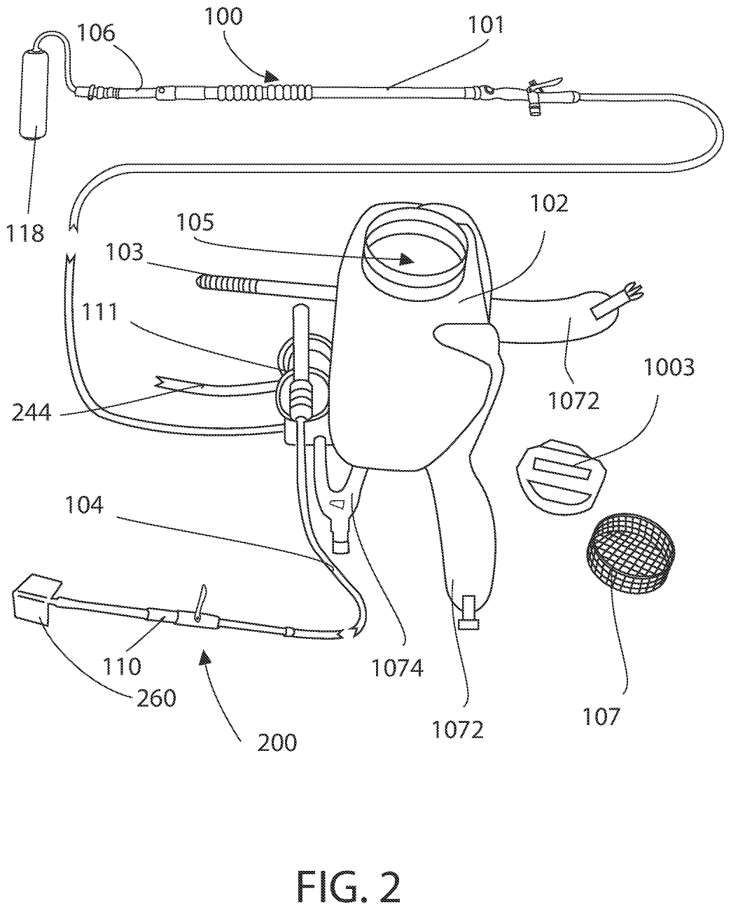

In an embodiment, the handle 106 is interconnected with a diaphragm pump manifold 111 for providing an interface for pressurized air from an air compressor 600 adapted for interconnecting a plurality of hoses 104 and the compressed air source in fluid communication with the contents of the container 102. The plurality of flexible hoses 104 are for conveying one of paint, drywall compound, or texture compound from the tank to respective applicators and the handle 106 may be comprised of a commercially-available wand such as may be fitted with threaded fittings onto a garden hose, whereas the end of the handle that is adapted to be adjacent the roller comprises a commonly-available threaded connector 129 commercially available for threaded attachment of a roller or paint pad on the end of the handle, as is available for washing cars. Paint, drywall compound, or texture compound is conveyed from the container 102 to the diaphragm pump manifold in via connector and valve combination 1074 as shown in FIG. 2. In each of the embodiments of the invention shown and described herein, a first hose 104 extends from the bottom of container 102, and a second hose 104 extends from the diaphragm pump manifold 111 as shown.

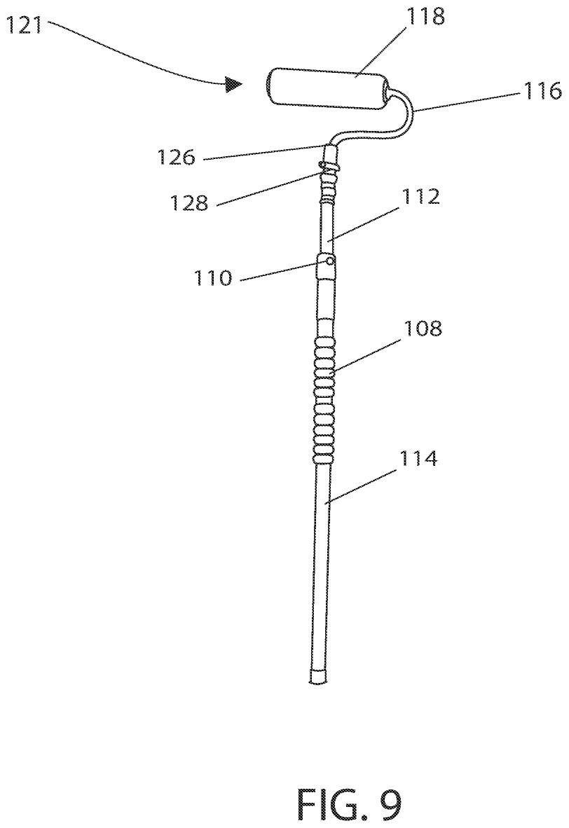

The handle 101 preferably has grips 108, and a twisted threaded release mechanism 110 (as shown in FIG. 9) for enabling extending and retracting of the handle 101 via telescoping means with one section 112 of the handle nested in another section 114 of the handle during a retracted state.

Material such as paint, texture material, or dry wall compound may be passed through a commonly available hose 104 that, in a painting embodiment interconnects with an available roller frame 116 attached atop the extensible handle 101, reducing the time needed to finish using the various application systems, such as he paint roller system or dry wall compound applicator system, by lessening the need to go back for more material. And cleanup is easily accomplished whether with water, for latex paints, or spirits traditionally used for cleaning oil-based paints.

The air compressor machine 600 comprises an air compressing mechanism that provides compressed air to the air flow hose 244. The air compressor machine 600 preferably comprises at least one air tank 253, a switch for turning the air compressor machine 600 on and off (not shown), a plug (not shown) to plug into an electrical outlet, and at least one pressure gauge (not shown).

Any known air compressor machine 600 in the art may be used. Preferably, the air compressor machine 600 is small enough to be portable to one location in the job site to another. However, a non-portable air compressor machine 600 can also be used if used with a very long air flow hose 244 that does not hinder the portability of the system 500. In an embodiment, the paint (or drywall compound or texture compound) passing through the hose 104 extending from the bottom of the container 102 is preferably pressurized by the manual pump handle 103, and the paint (or drywall compound or texture compound) passing through the hose 104 extending from the top of the diaphragm pump manifold 111 is in such embodiment preferably pressurized by an electric air compressor. Nevertheless, multiple such hoses 104 may be pressurized by a single compressor without departing from a broader aspect of the disclosure.

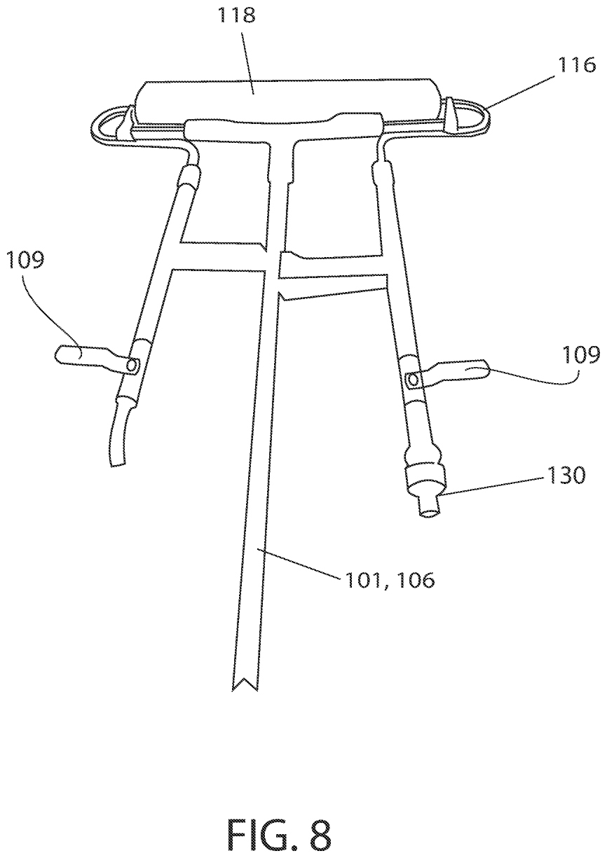

Referring to FIG. 8, there is provided an example embodiment of a large-scale paint roller system 118 with a handle 101 or 106, roller frame 116, and roller member 118. Other than its larger size, roller frame 116 and roller member 118 are suitable for use in a form similar to that of the roller member 118 of FIG. 9. However, this larger roller member 118 of FIG. 8 may be supplied by two hose members 104. Further, this larger roller member 118 may comprise an independent valve, or valves, as shown, to control flow of paint to the rollers.

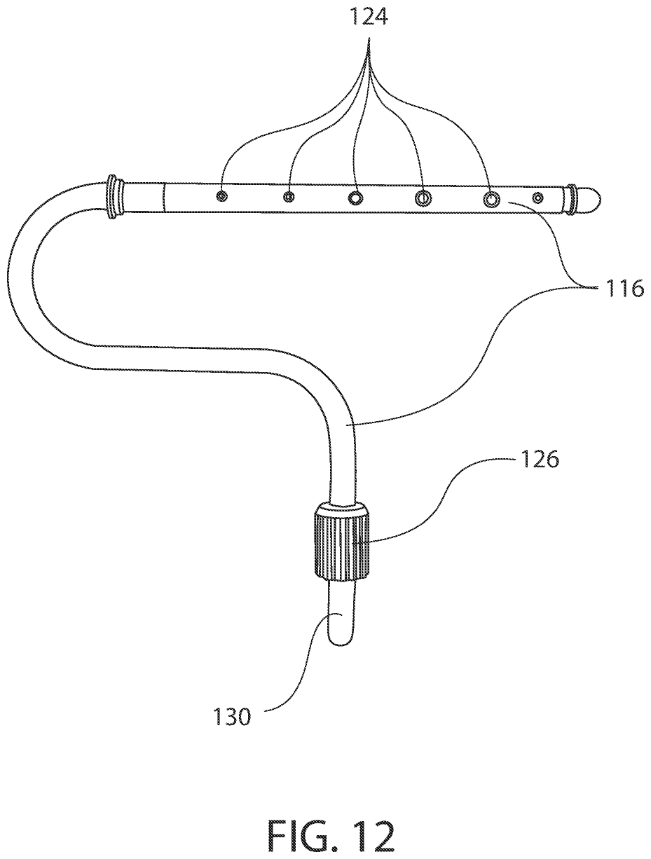

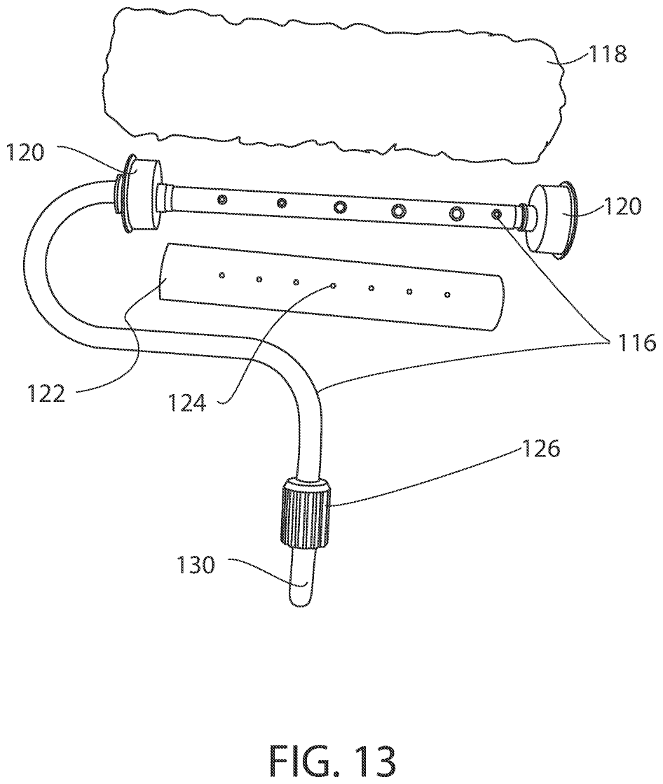

As shown more specifically in FIGS. 9-13, a pressure-fed curved, hollow, perforated, paint roller frame 116 is provided for rollably carrying a paint roller member 118, the roller member having an inner porous structure and an outer absorbent member as is known in the art. Two end caps 120 are provided for sealing a cavity 121 formed between the roller member 118 and the roller frame 116, and there may be provided a baffle 122 interposed in the cavity between the roller frame and the roller member to prevent excess paint and undue flow of paint. The paint roller frame 116 comprises perforations 124 for allowing paint to flow into the cavity 121. The paint roller frame 116 is adapted for being connected with a threaded connector 126 that is adapted to tighten down on a matching threaded end 128 of the extensible handle 101, 106. A ball and socket relationship is provided where necessary, for example between the frame 116 and the handle 101, 106, as well as at other locations in the paint roller system such as interconnecting of ends of the hose 104 to a container and the handle 106, where a good seal is required to prevent leakage of paint.

Any valves within the paint roller system, whether in the container or in the handle, may need to be enlarged as with a drill press to allow passage of a more viscous fluid, such as latex or oil-based paint, or drywall compound, as compared with water, typical liquid pesticides, or typical 30 liquid herbicides.

The paint roller system 100 of the hybrid system 500 comprises the same type of pressure-fed curved, hollow, perforated, paint roller frame 116 for rollably carrying a paint roller member 118, wherein the roller member also has an inner porous structure and an outer absorbent member as is known in the art. As with the first embodiment, there are further provided two end caps 120 for sealing a cavity 121 formed between the roller member 118 and the roller frame 116, and as described earlier, there may be provided a baffle 122 interposed in the cavity between the roller frame and the roller member to prevent excess paint and undue flow of paint. The paint roller frame 116 comprises perforations 124 for allowing paint to flow into the cavity 121. The paint roller frame 116 may be adapted for being connected with a threaded connector 126 that is adapted to tighten down on a matching threaded end 128 of the shorter handle 106 or longer handle 101, 106. Thus, it will be appreciated that the various components of the embodiments described herein may be intermixed and matched as necessary to achieve desired flexibility and results.

Further, a ball-and-socket-type relationship 130 also may be provided where necessary, for example between the frame 116 and the handle 106, as well as at other locations in the paint roller system such as interconnecting of ends of the coiled hose 104 to the container 102 and the smaller handle 106, where a good seal is required to prevent leakage of paint. This ball-and-socket-type relationship 130 is provided in novel fashion by heating of the coiled flexible hose to enable insertion of a sealed ball-type transition member 135 into the hose 104 and adapted for nesting with a correspondingly concave, partial bowl-shaped, 20 receptacle, or socket member, 145, all as further described herein, to allow adaptation of an otherwise commercially available garden sprayer to a higher-capacity, enhanced continuous, powered roller painting system 100 as part of a hybrid system 500.

Thus, valves within the paint roller system 100 of the hybrid system 500, whether in the container or in the handle, may need to be enlarged as with a drill press to allow passage of a more viscous fluid, such as latex or oil-based paint as compared with water, typical liquid pesticides, or typical liquid herbicides, and the aforementioned adaptation must be applied in a novel manner so as to adapt the commercially-available garden sprayer to become a pressurized paint rolling system 100.

Once the container 102 is filled with paint, the user may pressurize the cylinder 156 by actuating the pump handle 103 carried on the container 102 and then, or before to simply pump paint into the roller, engage the lever 109 and latching lock as necessary, and thereby feed paint through the coiled hose 104 into the shorter handle 106, into the roller frame 116, through the cavity 121, and into the roller 118 for enabling enhanced continuous rolling capability.

The pump handle 103 is preferably pivoted to and at a lower position on the container 102, and there is a pivotable linkage member interconnecting the pump handle and the pressurized cylinder 156. Actuation of the pump handle 103 therefore activates the linkage member in order to pressurize the cylinder 156 with paint in it, much as a manual reciprocating air pump would be reciprocated to pressurize a bike tire using a cup, cylinder, and valve system.

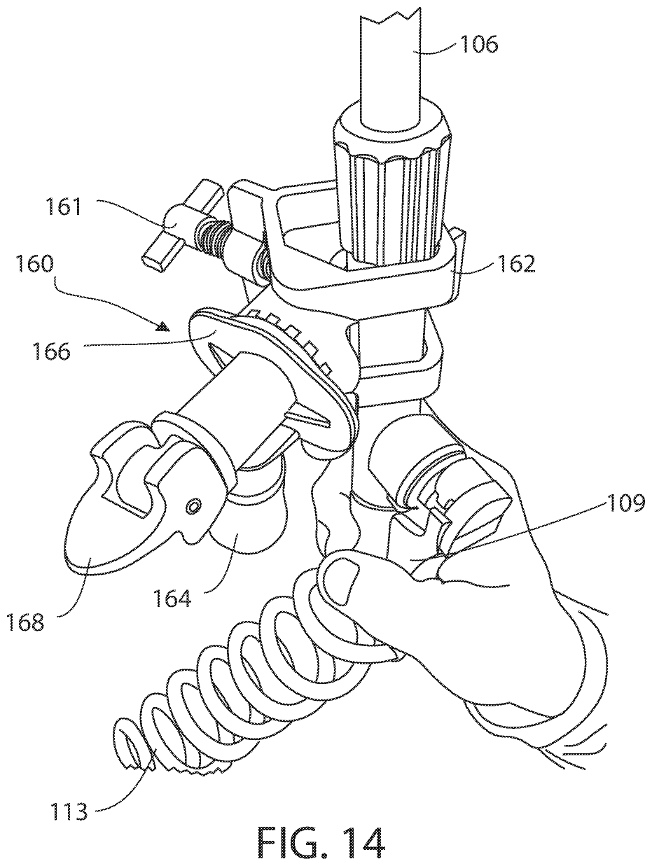

Referring specifically to FIG. 14, there is provided a commercially-available somewhat universal interconnection member 160 for interconnecting the shorter handle 106 to portion 112 of pole 101 of this embodiment of the paint roller system 100 of the hybrid system 500. The interconnection member 160 thus has a clamp system 162 with a threaded wing-nut type screw 161 adapted for clamping the interconnection member onto the shorter handle 106, and it has a threaded receptacle 164 adapted for receiving a matching threaded end on portion 112 of pole 101. The interconnection member 160 further comprises an indexing, rotatably-lockable, pivot member 166 with a thumb-actuated tightening cam adapted for allowing repositioning and locking in position the angle of use of the roller 118 and paint supply frame 116. This feature particularly allows for enhanced continuous painting of large and sometimes varying angle surfaces with the system of the paint roller system 100.

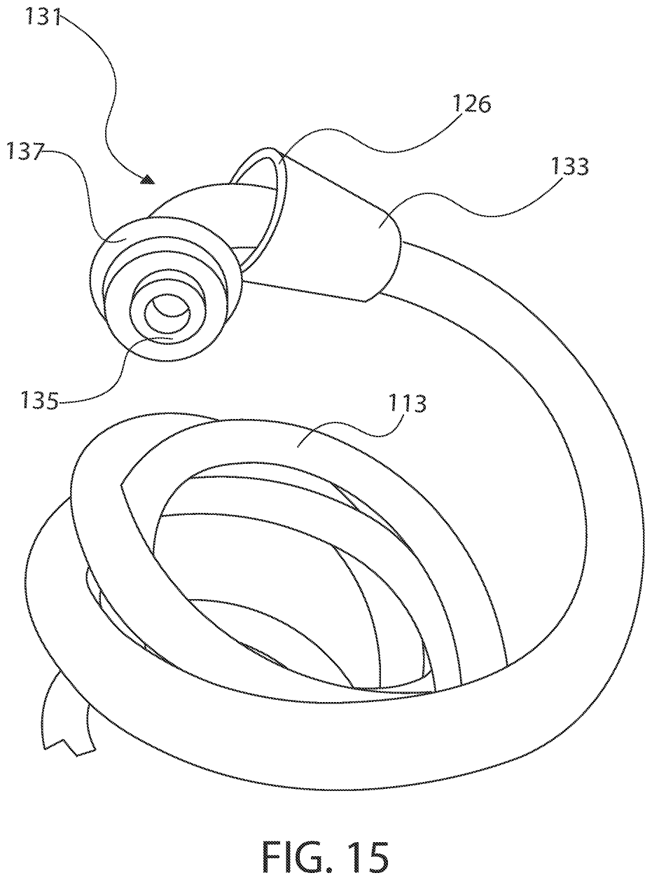

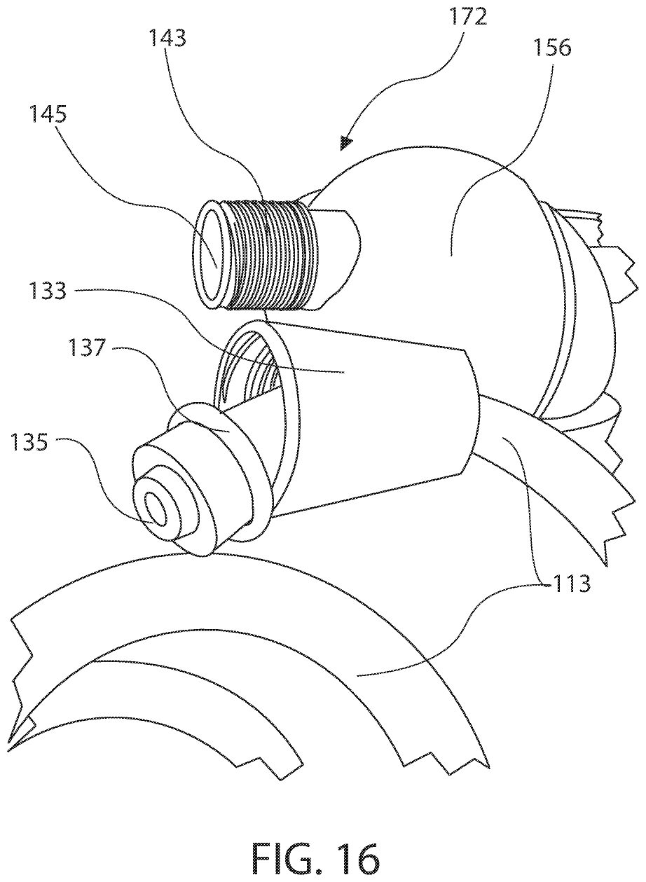

Referring specifically to FIGS. 15 and 16, there is a detailed view of novel interconnections created for the coiled hose member 1 and the commercially available container 102 with available pressurized cylinder 156 and its outlet port 172. Since the commercially available container 102 is intended for a different spraying purpose, several of the outlets and inlets of the paint roller system are too small to accommodate thicker, more viscous, paint. Further, the type of hose typically used for such available containers 102 are of a different character and type than that suitable for present purposes as is the coiled, or curly, supply hose 104. Therefore, the present disclosure comprises an improved interconnection system 131, and method for making the same, for such otherwise available products (container 102 and hose 104). The interconnection system 131 comprises a threaded thumb-actuated cap 133, an inner convex-end inner sleeve member 135, and an o-ring 137. Threads of the cap 133 corresponding with threads 143 of outlet port 172 of pressurized cylinder 156, for example, to enable screwing of the cap down on the outlet when the convex shape of the inner 130 convex-end insert member 135 is engaged with a mating concave bowl-shaped portion 145 of the outlet port 172. This interconnection system 131 provides a leak-proof seal so that paint cannot escape the interconnection, and this interconnection may be used between the hose 104 ends and the container 102, the pressurized cylinder 156, and the handle 106 to hose end connections as well.

To achieve the previously-described seal, a method of creating the interconnection system 131 for adapting previously-existing components (i.e., the coiled hose 104, the pressurized cylinder outlet port 172, and a pressurized paint rolling system handle 106) for an enhanced continuous paint roller system 100 as follows (with heat resistant gloves):
a. Heat the end of the hose 104 to soften the hose material;
b. Quickly insert the cap 133 over the end of the hose 104;
c. Quickly insert the o-ring 137 over the end of the hose 104
d. Insert the convex-end inner sleeve member 135 into the end of the hose 104; and
e. Allow the hose material to cool, contract and tighten around the convex-end inner sleeve member 135.

In addition to the foregoing modification, to adapt a commercially available sprayer such as that shown, such as a Ryobi® sprayer, or a Greenwood® sprayer, for use as an enhanced continuous pressurized paint rolling system in accordance with one or more aspects and embodiments of the disclosure, the following steps are provided as may be necessary:
a. Make sure all fluid system lines previously designed for less viscous liquid, including ports, and inlets, are adequately sized; and
b. Select desired extensible pole 142 with appropriate threaded connections adapted to fit the paint roller frame 116 on the end of handle 106 with appropriate seated concave/convex seal interconnection systems 131 and collars, caps, or twisting threaded interconnection members, e.g., 126, to appropriately seal areas where paint will be adapted to flow through such components.

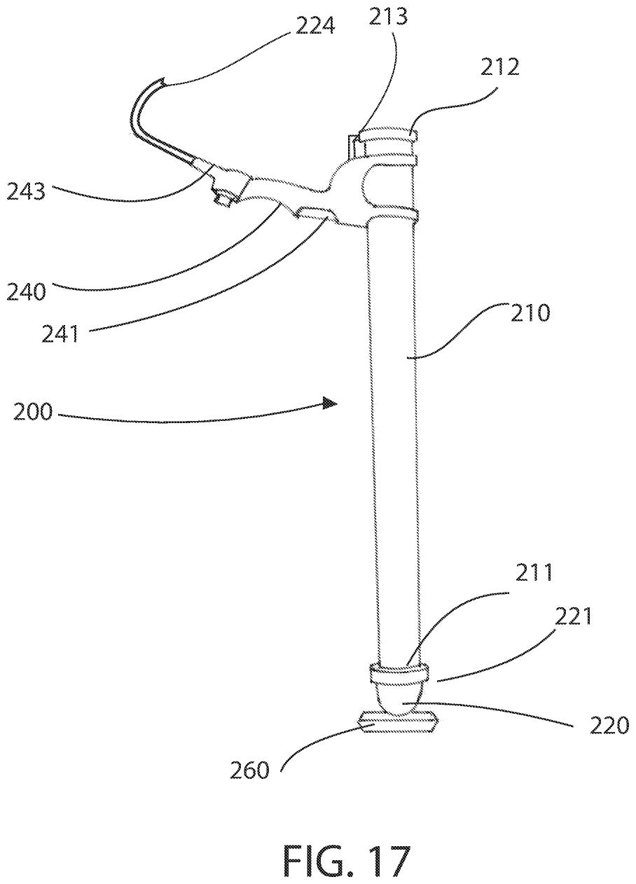

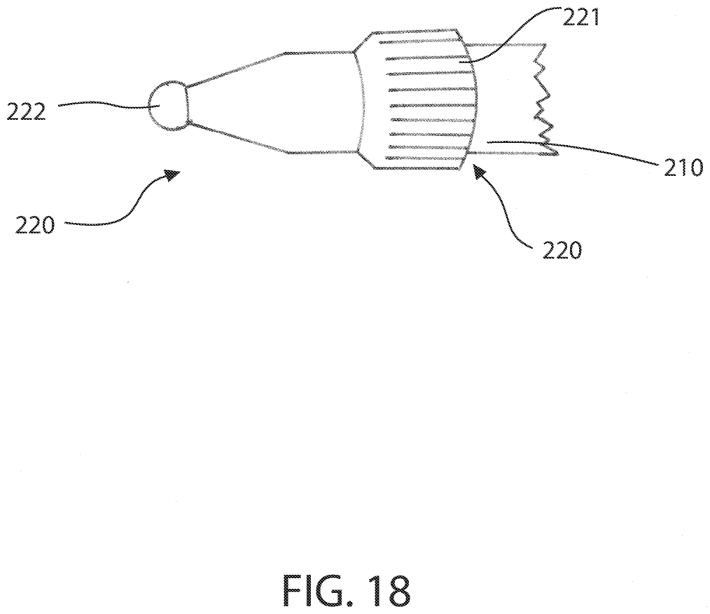

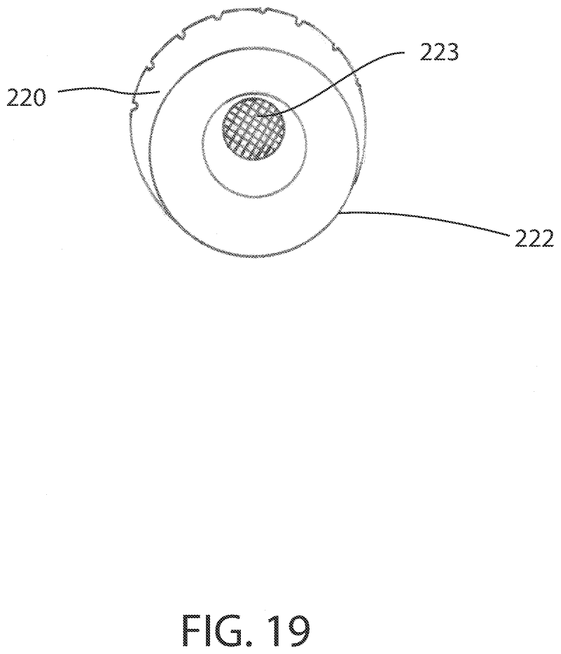

Referring to FIG. 17, there is provided a side perspective view of the dry wall compound applicator system 200 of the hybrid system 500 in accordance with an aspect and embodiment of the disclosure. The dry wall compound applicator system 200 has the tube 210 with the first end 211 and the second end 212. The tube 210 also comprises a port 213 near the second end 212 for introducing pressurized air into the tube 210 from an air compressor machine. Thus, the tube 210 is adapted for being at least partially filled with compressed air near its second end 212. The tube 210 is also adapted for being at least partially filled with the dry wall compound and is portable around a jobsite. The first end 211 of the tube 210 is attachable and detachable to the funnel 220 by threaded engagement near the edge 221 of the funnel 220. The funnel has the tip 222 (shown in FIG. 18-19) that is attachable and detachable to an applicator 260.

A handle 240 is attached near the second end 212 of the tube 210. The handle 240 is preferably a pneumatic handle 240. The handle preferably has a finger-operable trigger 241 adapted for communicating air from the air compressor machine through the port 213 and into the second end 212 of the tube 210 when triggered. Thus, when the tube 210 is filled with the dry wall compound, triggering the pneumatic handle 240 causes air pressure to fill behind the dry wall compound in the tube 210. The trigger 241 therefore allows a user to put air pressure into the tube 210 to dispense the dry wall compound. The pneumatic handle 240 preferably has a connecting portion 243 attachable to an air flow hose 244. The air flow hose 244 is preferably attachable to a connecting valve of the electrified air compressor machine.

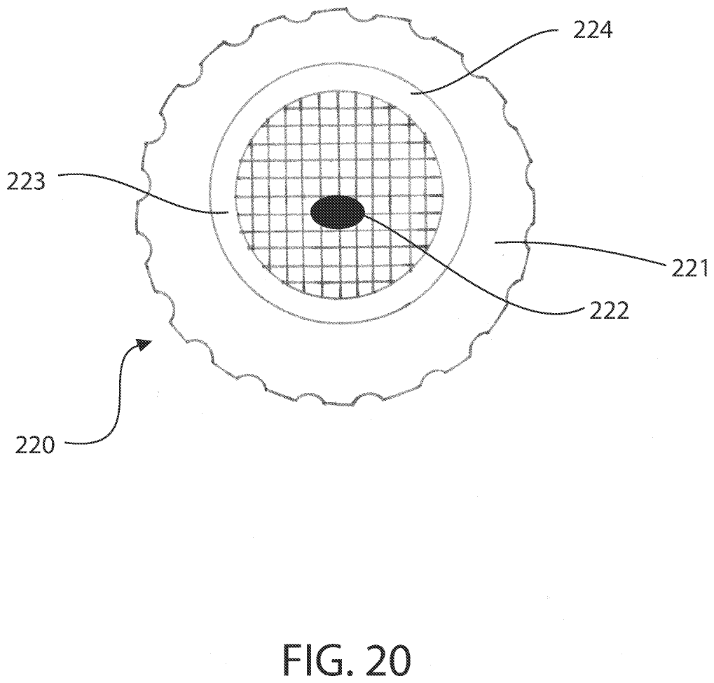

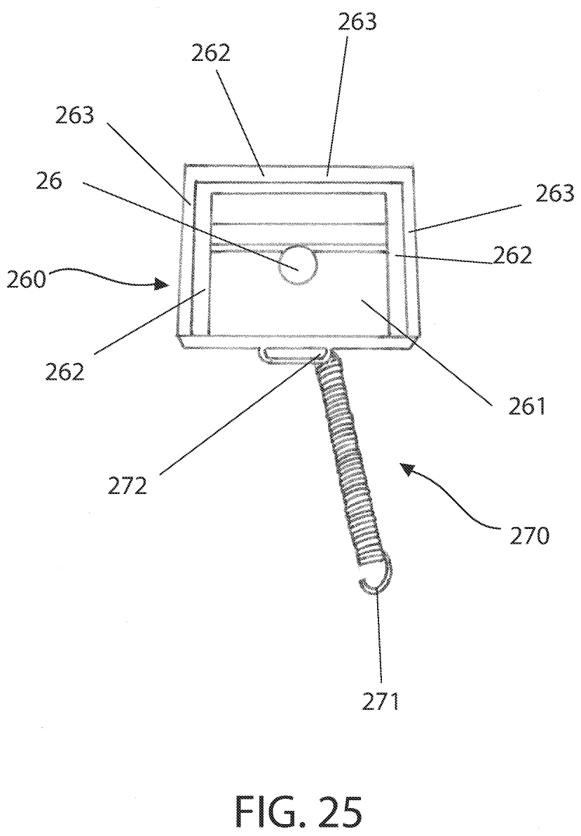

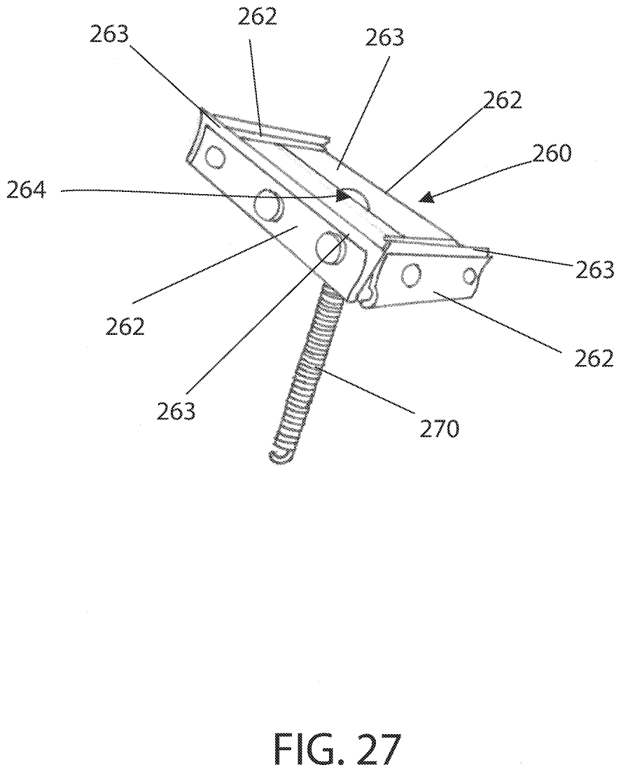

Referring to FIGS. 18-20, there is shown the funnel 220 in more detail. A side perspective view of the funnel 220 attached to the tube 210 of the dry wall compound applicator system 200 is shown in FIG. 18. The funnel 220 preferably has an edge 221 that is attachable and detachable to the first end 211 of the tube 210. The funnel 220 shown is partially conical and partially cylindrical shaped. However, other shapes known in the art can be used for the funnel 220 shape. The funnel preferably has a ball-shaped tip 222. However, the tip 222 can be of different shape as known in the art. The ball-shaped tip 222 is attachable and detachable via a threaded connection to various applicators 260 (shown in FIGS. 25-29). FIG. 19 shows a front perspective view of the funnel 220. The ball-shaped tip 221 has an opening for filling and dispensing drywall compound. Through the opening, a mesh 223 is visible. How the mesh 223 attaches to the funnel 220 is shown in FIG. 20. The mesh 223 fits or attaches perpendicular to inner circumference 224 of the funnel 220. The mesh preferably is attachable and detachable, but the mesh 224 can also be permanently fixed to the inner circumference 224 of the funnel 220. The mesh 224 acts to filter the dry wall compound as it dispenses, so any large residue will not be dispensed, allowing for smooth dispensing of dry wall compound for easy and even application of the dry wall compound. The mesh 224 also may control the flow of the dry wall compound as it dispenses, allowing for more stable slow. Though not shown, this funnel may be threaded for easily attaching it to the applicator tube for dispensing drywall compound.

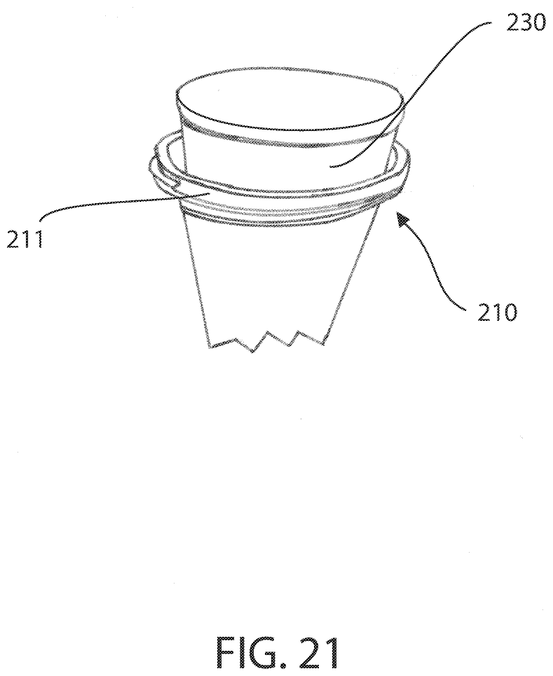

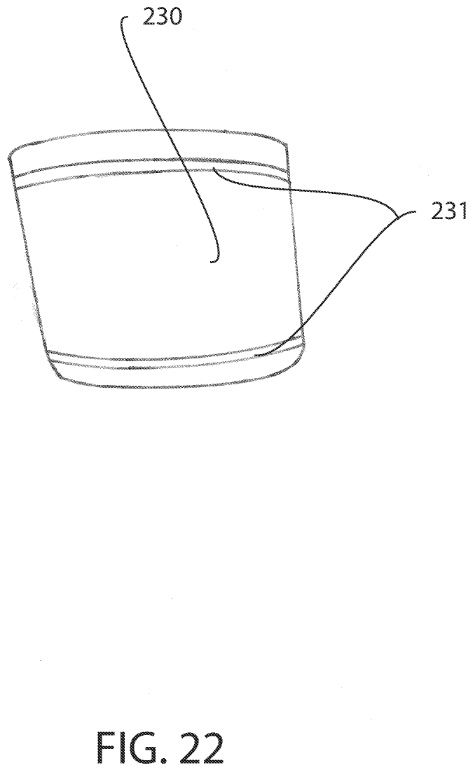

Referring to FIGS. 21-22, there is provided a linearly movable diaphragm insert 230 removable and slidable inside the tube 210. FIG. 21 shows a perspective view of how the insert 230 can be inserted into the tube 210 at the first end 211 of the tube 210 in accordance with an aspect and embodiment of the disclosure. The insert 230 is preferably inserted into the tube 210 before sucking of the dry wall compound into the first end 211 of the tube 210 during the loading mode by one of pumping dry wall compound into the first end 211 of the tube 210 and evacuating compressed air from the second end 212 of the tube 210, and before attachment of the applicator 260 (shown in FIGS. 25-29) on the ball-shaped tip 222 of the funnel 220 (shown in FIGS. 18-20). Thus, the insert 230 is adapted to be located behind the dry wall compound. However, in another embodiment, the insert 230 may be loaded differently, such as being inserted near the second end 212 of the tube 210 or at the second end 212 and then slid into the first end 211 of the tube 210. During an applicating mode, pressurized air is applied through the port 213 (shown in FIGS. 17, 23-24) near the second end 212 of the tube 210, and the pressurized air is thus located behind the insert 230, which is located behind the dry wall compound. Upon activating the trigger 241 of the pneumatic handle 240 (shown in FIGS. 17, 23-24) during the applicating mode, pressure pushes against the insert 230 to apply steady force to the dry wall compound in the tube 210 to cause the dry wall compound to flow out of the ball-shape tip 222 of the funnel 220 and the applicator 260 body 261 (shown in FIGS. 25-29) attached to the tip 222 of the funnel 220 for even application of dry wall compound to a wall. While the insert 230 in FIGS. 21-22 is cylindrical in shape, other shapes and forms known in the art may be used, such as a disc or a ball. The insert 230 has a pair of o-ring seals 231 to help it retain the air behind the insert so that it will be more powerful in pressing against the dry wall compound.

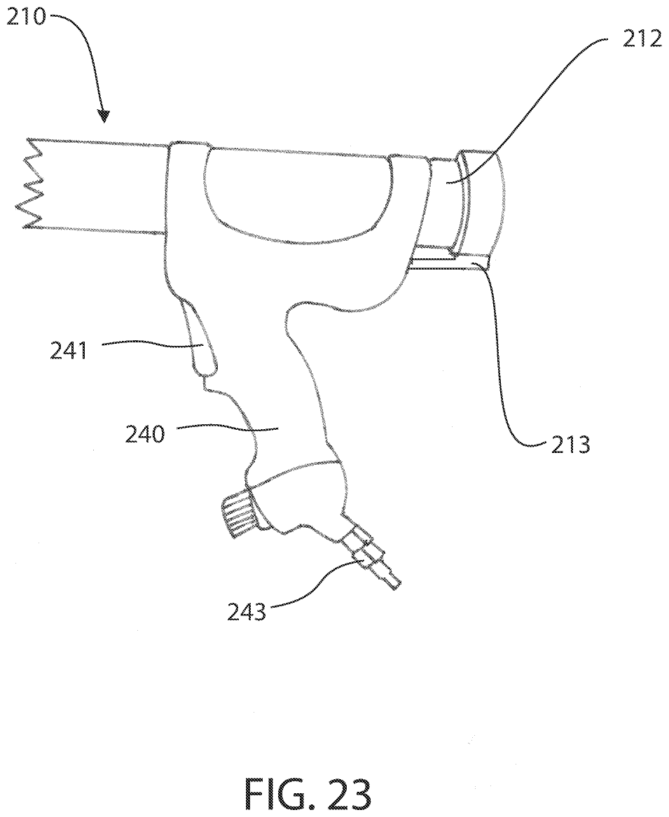

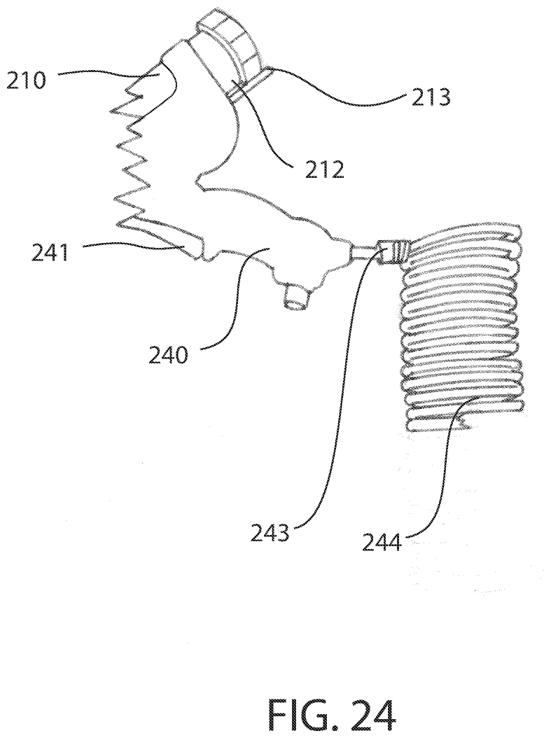

Referring to FIGS. 23-24, the pneumatic handle 240 is provided in more detail. The pneumatic handle 240 attaches preferably to near the second end 212 of the tube 210. The handle 240 may be differently positioned, as known in the art, such as nearer to the middle of the tube 210. The pneumatic handle 240 comprises a trigger 241, preferably hand operable, and the connecting portion 243 for attaching the air flow hose 244, as seen in FIG. 24. The pneumatic handle 240 also connects with the port 213 at the second end 212 of the tube 210 to provide compressed air from the electrified air compressor machine 600 when fully connected. The handle 240 can be of any shape known in the art.

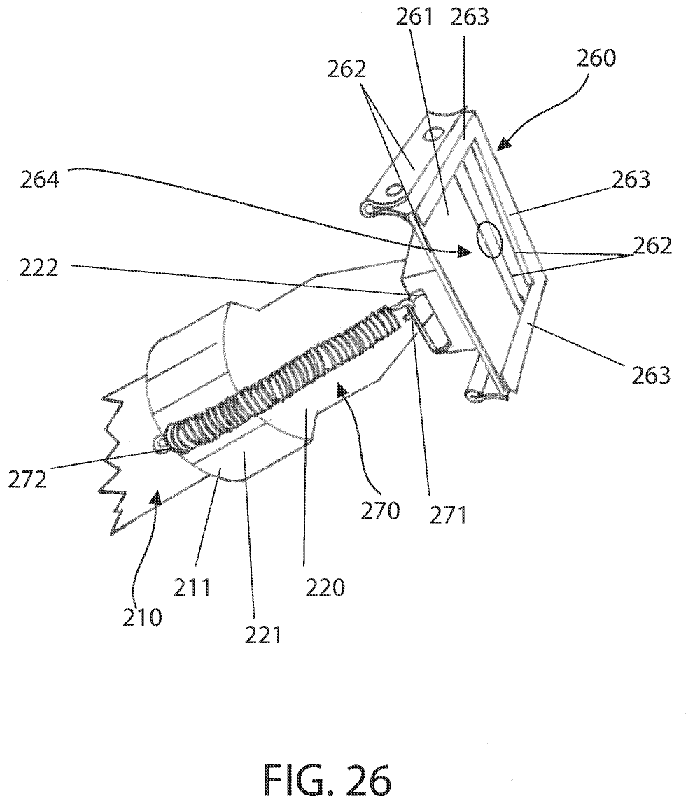

Referring to FIGS. 25-27, there is provided an applicator 260 according to an embodiment of the disclosure. FIG. 25 shows an above perspective view of the applicator 260 attached to a spring 270. The applicator 260 has a body 261 with a connecting portion 264, which is preferably a central circular hole 264. The central circular hole 264 is attachable and detachable to the ball-shaped tip 222 of the funnel 220, as seen in FIG. 26. Any known connecting portion 264 shape with complimentarily shaped tip 222 for the funnel 220 can be used in an embodiment. The circular hole 264 is preferably in the center of the body 261 of the applicator 260 but does not need to be in other embodiments. The applicator 260 preferably comprises at least one edge 262. The at least one edge 262 may be comprised of squeegee material 263. As shown in FIGS. 25-27, the body 261 can be rectangular shaped with four edges 262, with three of the four edges 262 comprising squeegees 263. In the embodiment shown, one edge 262 is preferably connected to the spring 270 by its second end 272 to facilitate control of the applicator during usage. The first end 271 of the spring 270 is preferably connected to the funnel 220, as shown in FIG. 26. In the embodiment shown, the first end 271 of the spring 270 is attached to the edge 221 of the funnel 220. However, the first end 271 of the spring 270 can be attached to any portion of the funnel 220 that gives it enough spring tension for providing pressure as the applicator 260 moves along the wall, to provide stability and control over the applicator 260 while applying the dry wall compound. In another embodiment, the first end 271 of the spring 270 may also be attached to the tube 210 instead. In another embodiment, multiple spring 270 may also be used instead. The spring 270 may be attachable and detachable or permanently attached by at least one of its ends 271, 272.

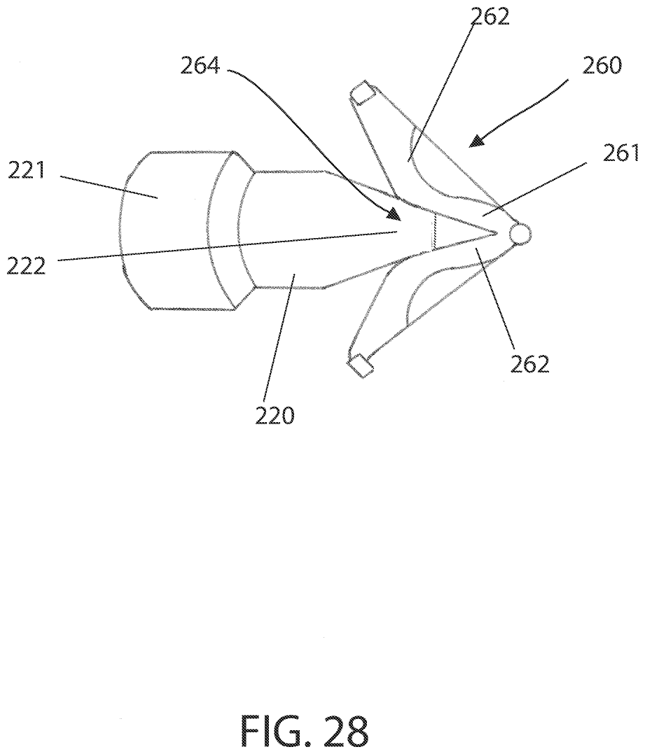

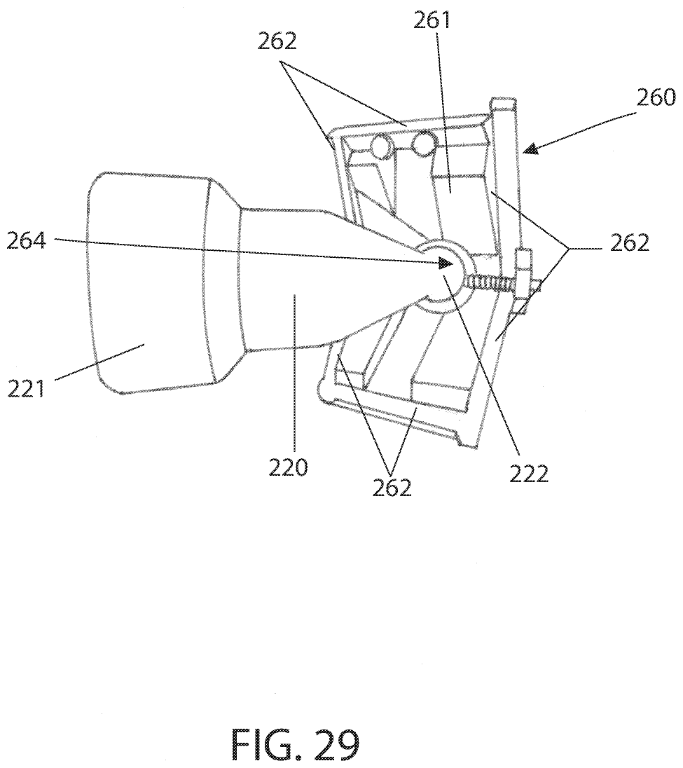

Referring to FIGS. 28-29, there is provided another embodiment of the applicator 260. The applicator 260 as shown has a L-shaped body 261, comprising six edges 262 with no squeegees 263 (shown in FIG. 25-27) on any of the edges 262. The applicator 260 as shown also has central circular hole 264 that connects to the funnel 220 by the tip 222 of the funnel 220. No spring 270 (shown in FIG. 25-27) is attached to the applicator 260 or the funnel 220. However, a spring 270 or squeegee 263 are preferably present in a preferred embodiment.

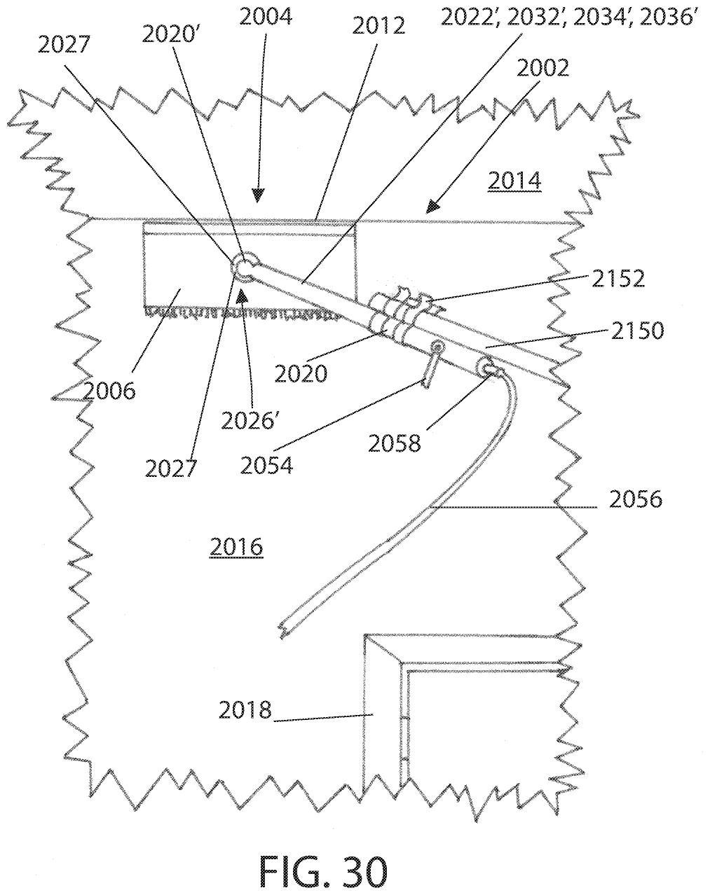

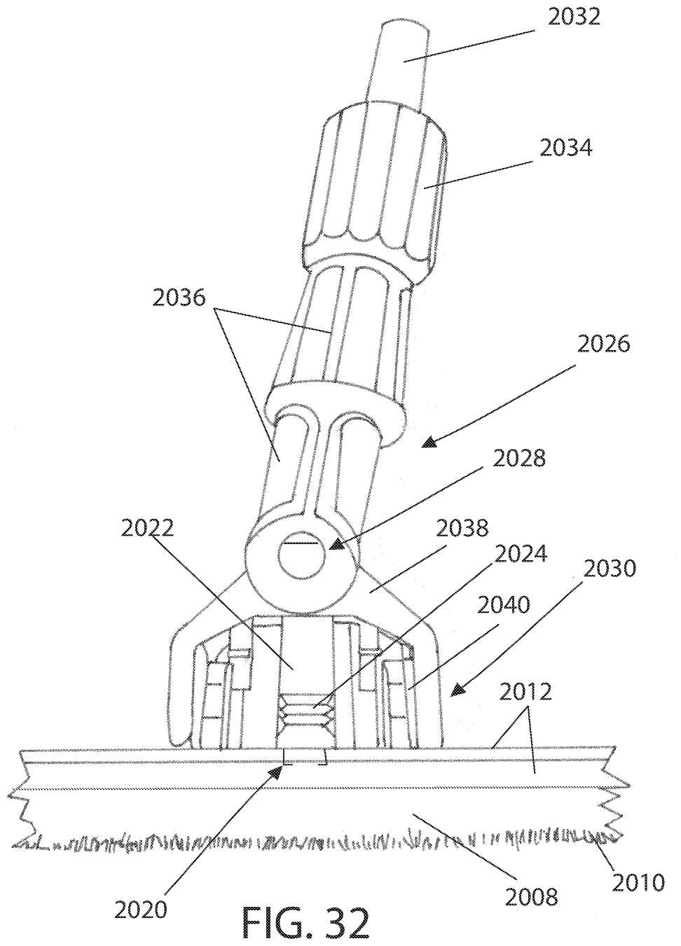

Referring now to FIGS. 30-33, there is provided an embodiment of a higher-capacity, portable, enhanced continuously-fed, paint pad painting system 2002 (e.g., similar to that shown and described above in connection the powered paint roller system of FIGS. 8-16) and an improved edge-cutting porous paint pad 2004 adapted for receiving paint from such a pressurized continuous-flow paint system, the improved edge cutting porous paint pad 2004 comprising: a planar base member 2006 with at least a linear edge 2007, a sponge-type layer portion 2008 with at least a linear edge 2009 aligned with linear edge 2007, a fibrils layer portion 2010 (e.g., thin finger-like projections) with a substantially linear edge 2011 aligned with linear edges 2007, 2009, and an edge spacer member 2012, preferably made of plastic.

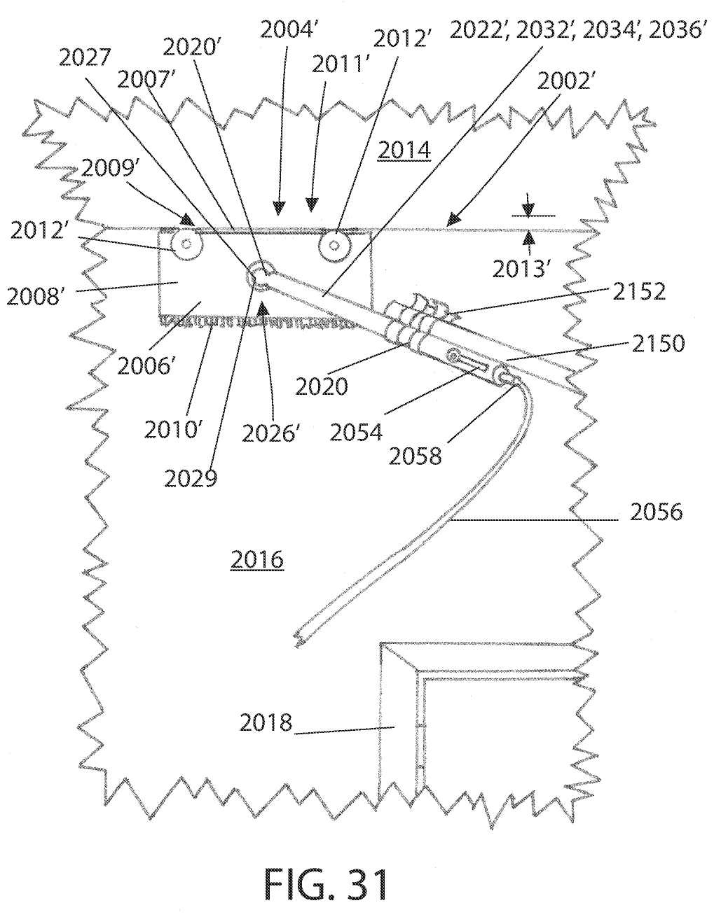

The edge spacer member 2012 is aligned with the linear edges 2007, 2009 of the base portion 2006 and the sponge-type layer portion 2008, as well as the substantially linear edge 2011 the fibrils layer portion 2010, and it extends outwardly away from the fibrils portion by the spacing of a gap 2013, of approximately ⅛^{th} inch, so as to create a barrier against paint getting onto a surface (e.g., a ceiling 2014) when a user is painting an adjacent surface (e.g., a wall 2016) typically forming a 90 degree angle with the surface not to be painted. (For perspective a door frame 2018 is shown in FIGS. 30 and 31) The edge spacer member 2012 may be glued, otherwise attached, or formed integrally with the base member 2006, and these may be preferably made of plastic.

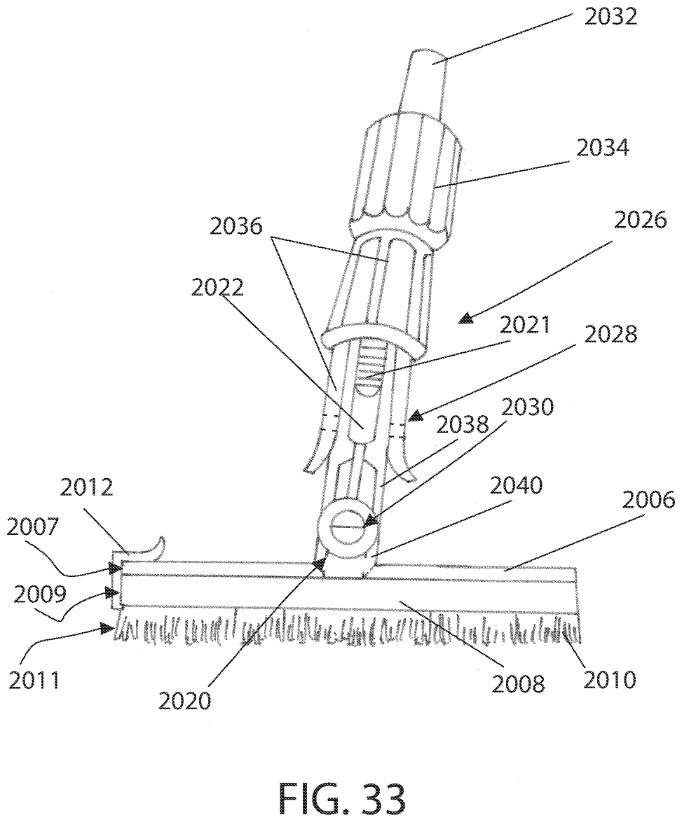

The edge-cutting porous paint pad base member 2006 comprises an aperture 2020 which is adapted to communicate paint from a conduit 2022 and a lower secondary nipple 2024 (an upper secondary nipple 2021 is shown in FIG. 33, and the conduit 2022 extends to carry paint between the two secondary nipples). The multi-direction deflection member 2026 comprises at least first and second pivot points 2028, 2030 (at 90 degrees to each other) to enable deflection of the paint pad frame 2006 in at least two directions of pivoting motion. Optionally, as shown in FIGS. 30 and 31, there may be provided alternative multi-direction deflection members 2026′ (such as a ball and socket member) for further multi-directional deflection capability.

There is provided an upper main paint conduit nipple 2032, with a threaded collar 2034 for threading onto a handle (e.g., handle 2020), and there is a housing 2036 adapted for carrying paint, as with an internal or integral conduit, within the multi-direction deflection member 2026, 2026′. A universal member 2038 is also provided which is pivoted at 2030 to a frame extension 2040 extending (for example integrally) from base 2006.

As shown in FIGS. 30, 31, an alternative embodiment multi-direction deflection member 2026′ comprises a socket 2027 and a ball 2029, to enable deflection of the paint pad frame 2006, 2006′ in multiple directions of pivoting motion.

In the alternative embodiment of FIGS. 30, 31, the upper main paint conduit nipple 2032′, 2034′, 2036′ are just threaded portions of conduit housing/deflection frame for threading onto a handle (e.g., handle 2020 or 2150), within the multi-direction deflection member 2026′.

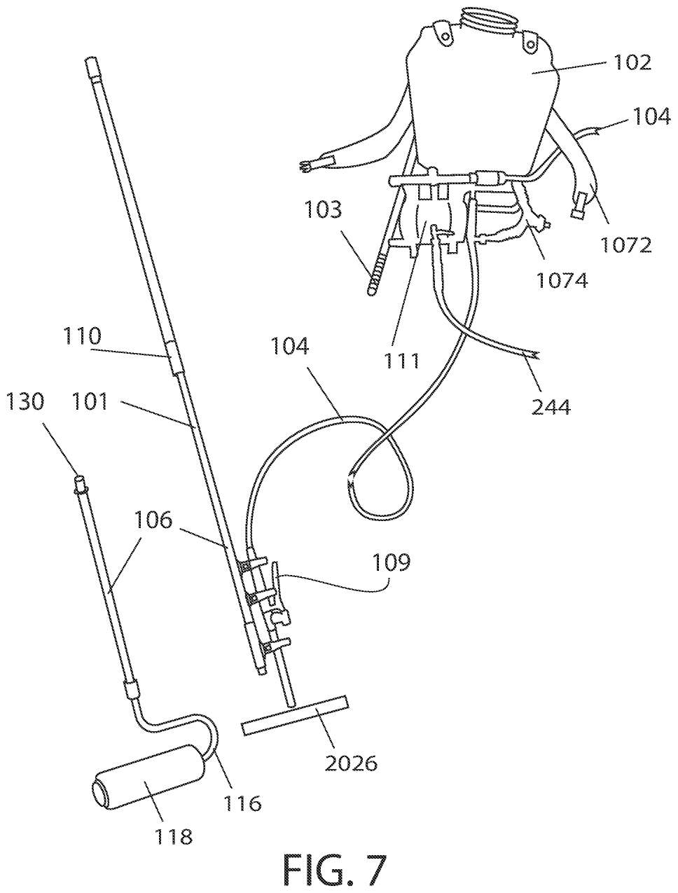

Referring again to FIGS. 30 and 31, it will be appreciated that the power paint supply systems of FIGS. 7-16 may be implied in these FIGS. Thus, there is provided a handle member 2020, an extension pole 2150 which may be attached to handle 2020 via clamp members 2152. As with other paint supply systems shown in FIGS. 7-16, there is provided a valve 2054 (shown in an off position in FIG. 30 and an on position in FIG. 31), and a supply hose 2056 attached with a rotatable fitting 2058, to enable the supply of paint to the paint pad system 2002, 2004, 2002′, 2004′.

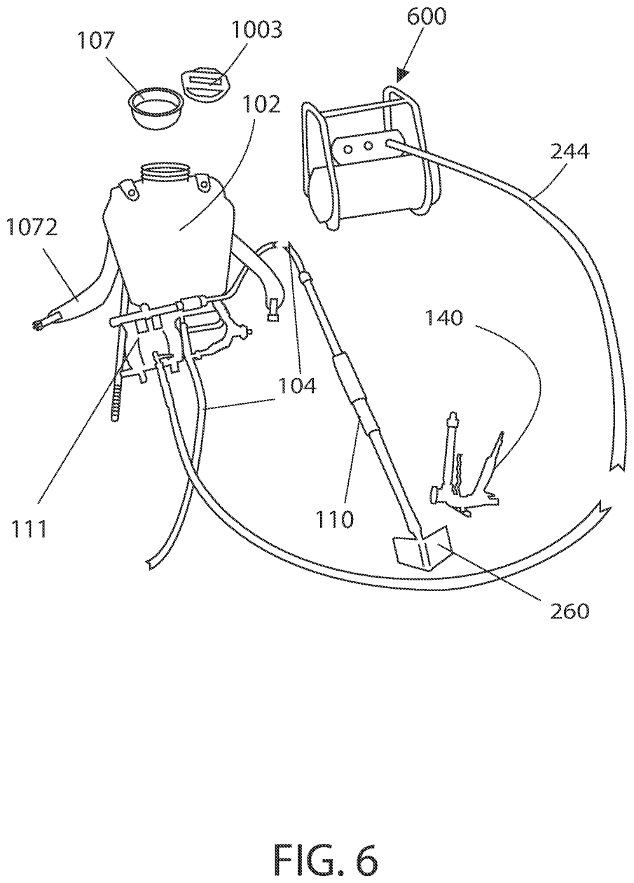

As shown in FIGS. 1 and 6, there is provided a commercially available texture spray applicator gun 140 for use with the system 500, and which may be optionally interconnected with either hose 104.

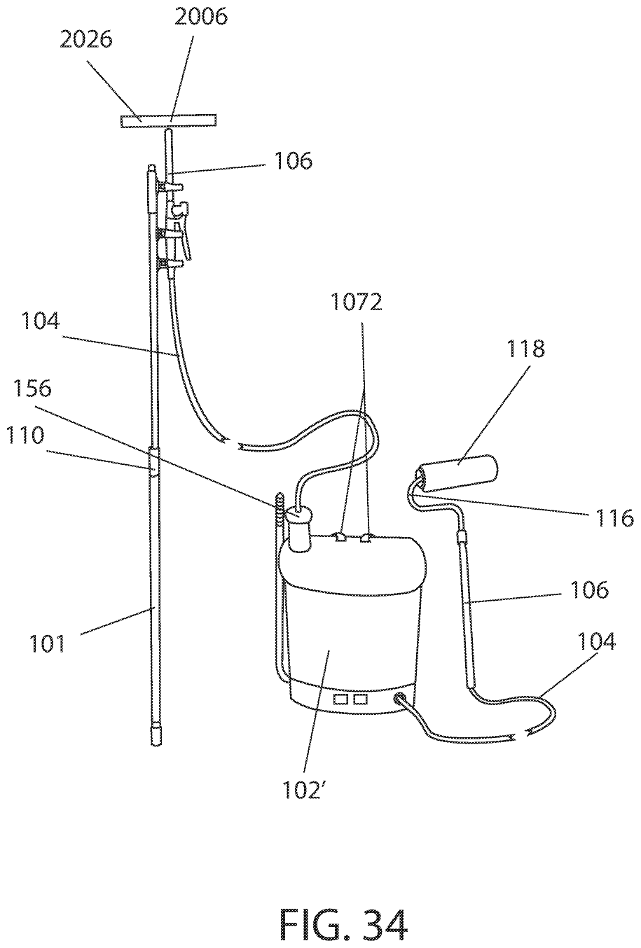

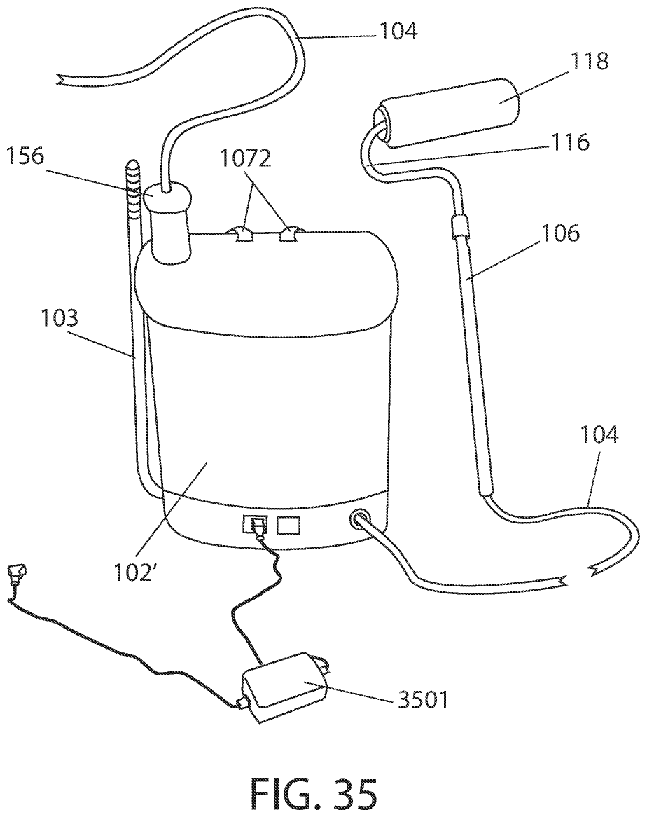

Referring now to FIGS. 34 and 35, there is shown an alternative embodiment electric powered paint hybrid applicator system, which allows simultaneous application of paint by two workers, whether power roller and/or power paint pad application. As with other embodiments of the hybrid system 500, this alternative embodiment comprises a container 102′, a pressurized chamber 156, an applicator hose 104, a handle (e.g., similar to handle 101, 106, 1022, 2020, or 2150) connected to the hose 104 and for supplying paint to a roller 118 carried on a roller frame 116 and the handle 106. Further, the system comprises a longer extendible pole 101, another applicator hose 104, and another handle 106 on the end of which is provided a paint pad frame member 2026 and paint pad 2006 for allowing cutting of edges as described previously herein.

In other previous embodiments described herein the term hybrid system has referred not only to the fact that multiple workers may use the device simultaneously, but also to the fact that the same device may be used for different mediums at different times (such as oil-based paint, water-based paint, drywall compound, texture compound), whereas with this latter alternative embodiment, the term hybrid refers to the fact that multiple workers may use the same device simultaneously to apply paint, whether in simultaneous similar operations or simultaneous dissimilar operations. Thus, for example, while one worker is painting with a powered paint roller 118, another worker may follow behind simultaneously and cut in edges using the powered paint pad applicator 2006, both powered by the same device and using the same container 102′. Or, for another example, two workers may work together simultaneously with powered paint rollers 118 feeding from the same device and using the same paint container, or reservoir 102′. Or, for yet another example, two workers may work with powered paint pad applicators 2006 powered by the same device. The hybrid system of FIGS. 34 and 35 show how, in an embodiment, a manifold for distributing paint may be internal of the container, or alternatively otherwise, there may simply be two or more outlets, or hoses 104, for distributing paint from the same container without departing from an aspect of the invention in one of its broader aspects and embodiments.

As shown in FIG. 35, the device of this latter alternative embodiment is shown as used with rechargeable batteries, such as with Lithium Ion batteries or other suitable batteries, adapted to be charged with a plug and adapter 3501 for allowing charging of the optional batteries of the system.

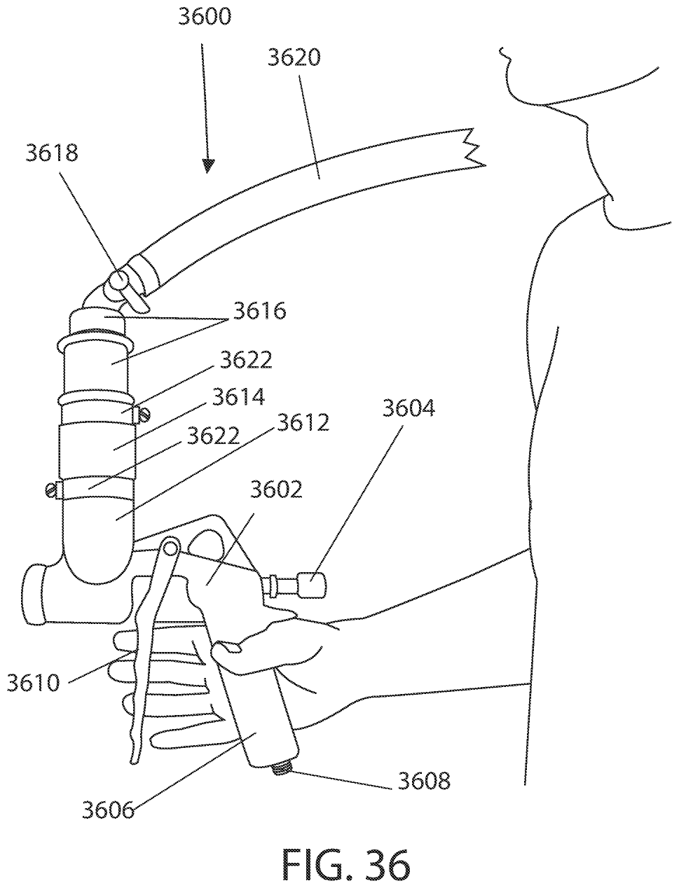

As shown in FIG. 36, there is further provided an improved texture applicator, or spray gun, 3600 adapted for use with a continuous supply of spray texture compound by way of an over-the-shoulder hose 3620 feeding into an inlet port 3612 of more traditional texture applicator 3602 as supplied via the hybrid system of this disclosure. The improved texture applicator 3600 is easier to use and control than prior art models, since it does not require the heavy hopper of material resting upon the inlet port of a prior art applicator. The improved applicator 3600 comprises a gun portion 3602, having an adjustable flow control knob 3604, and a stock 3606 from which a pressurized air nozzle 3608 was provided in the prior art. However, in the improved model, the texture material comes pressurized via hose 3620 for even application on a wall. The user actuates the spray gun 3600 via a trigger 3610. An independent shutoff valve is provided at 3618. Thus, the hose 3620 interconnects first or second outlet ports of the hybrid system with the hopper 3612 of the spray gun 3600. The hose 3620 is attached to the hopper 3612 via connectors 3614, 3616, of which one may be a commonly threaded connector (as in a plastic garden hose threaded connector 3616) and/or a rubber hose clamp interconnector connector 3614 adapted to be clamped to the connector 3616 at one end and the hopper 3612 at the other end via traditional rubber hose clamps 3622.

It will be appreciated that the present invention allows for hybrid operations, whether the application of different types of mediums, or with simultaneous operations, or both. In this way, painting, drywall compound application, spraying, and texture application operations may be facilitated, made faster, and made more efficient. Further, the system may be preferably primarily comprised of existing components already available in the marketplace, though such is not a requirement of the invention, since it may also of course be manufactured as original equipment. Nevertheless, these facts provide a potential for cost savings to manufacturers, consumers, and commercial operations acquiring the system.

While preferred embodiments of the present invention have been shown and described, it will be appreciated that one of ordinary skill in the art will recognize the inventive principles disclosed are not limited to the embodiments disclosed herein, and that various aspects of the invention may be modified without departing from the true spirit of the invention as claimed. Thus, by way of example, it will be appreciated that this invention provides the user with a hybrid combinable system for an enhanced application of paint, dry wall compound, and texture, saving time and money in larger, for example commercial, paint jobs. Further, it will be appreciated that various components of the system, whether container types, handle types, flexible hose types, or other elements, may be mixed and matched without departing from the invention as claimed. The appended claims are therefore intended to cover all such changes and modifications as fall within the true spirit and scope of the invention.

What is claimed is:

1. A portable, stable flow, multi-use, hybrid system for application of any material of drywall compound material, paint material, and texture material by the hybrid system, comprising:
A pressurizable hollow tank having a sealable, openable opening adapted for insertion of material comprised of any one of drywall compound, paint, and texture compound, said tank further comprising a first outlet port for pressurized expulsion of the material being used at a given time, said tank further communicating with at least one other outlet port for simultaneous expulsion of material being used at the given time via the at least one other outlet port;
An air compressor adapted for pressurizing at least a portion of the material supplied from said tank at a given time;
At least one paint roller subsystem optionally detachably attachable to one of the first outlet port and the another outlet port, adapted for pressurized application of paint supplied from said tank to a surface via a paint roller;
At least one paint sprayer subsystem optionally detachably attachable to one of the first outlet port and the another outlet port, adapted for pressurized application of paint from said tank to a surface via a paint sprayer;
At least one drywall compound applicator subsystem optionally detachably attachable to one of the first outlet port and the another outlet port, adapted for pressurized application of drywall compound from said tank to a surface via a drywall compound applicator;
At least one texture applicator subsystem optionally detachably attachable to one of the first outlet port and the another outlet port, adapted for pressurized application of texture compound from said tank to a surface via a texture applicator; and
An edge-cutting porous paint pad subsystem optionally detachably attachable to one of the first outlet port and the another outlet port, adapted for pressurized application of paint from said tank to a surface via an edge-cutting porous paint pad.

2. The hybrid system of claim 1, wherein the second outlet port is adapted for simultaneous use of the system by a plurality of users, such that the plurality of users may simultaneously use the system to apply one of drywall compound, paint, and texture, whichever material happens to be loaded into the tank at a given time, wherein upon another time loading the system with another one of drywall compound, paint, and texture, the system is likewise capable of supplying such another one of material to a plurality of users, and depending upon which of the paint roll subsystem, said paint sprayer subsystem, said drywall compound applicator subsystem, said texture applicator subsystem, and said edge-cutting porous paint pad subsystem is optionally detachably attached to said tank.

3. The hybrid system of claim 2, wherein upon using the system for painting, one user may use one of said paint roller subsystem, said paint sprayer subsystem, and said edge-cutting porous paint pad subsystem, simultaneously while another user may use another of said paint roller subsystem, said paint sprayer subsystem, and said edge-cutting porous paint pad subsystem.

4. The hybrid system of claim 3, wherein said paint roller subsystem further comprises an attachable and detachable enlarged paint roller.

5. The hybrid system of claim 1, wherein said paint roller subsystem comprises a pole with the paint roller attached to an end of said pole, for allowing application of paint via a flexible hose interconnecting the paint roller and pressurized paint from said tank, and wherein said paint roller subsystem further comprises a trigger for independently controlling flow of paint through said paint roller subsystem.

6. The hybrid system of claim 1, wherein said paint sprayer subsystem comprises the paint sprayer for allowing application of paint via a flexible hose interconnecting the paint sprayer and pressurized paint from said tank, and wherein said paint sprayer subsystem further comprises a trigger for independently controlling flow of paint through said paint sprayer subsystem.

7. The hybrid system of claim 1, wherein the edge-cutting porous paint pad subsystem comprises a pole with the edge-cutting porous paint pad attached to an end of said pole, for allowing application of paint via a flexible hose interconnecting the edge-cutting porous paint pad and pressurized paint from said tank, and wherein said edge-cutting porous paint pad subsystem further comprises a trigger for independently controlling flow of paint through said edge-cutting porous paint-pad subsystem.

8. The hybrid system of claim 7, wherein the edge-cutting porous paint pad comprises a cutting edge adapted for facilitating painting straight edges.

9. The hybrid system of claim 1, wherein said drywall compound applicator subsystem further comprises a pole with the drywall compound applicator attached to an end of said pole, for allowing application of drywall compound via a flexible hose interconnecting the drywall compound applicator and pressurized drywall compound from said tank, and wherein said drywall compound applicator subsystem further comprises a trigger for independently controlling flow of drywall compound through said drywall compound applicator subsystem.

10. The hybrid system of claim 9, wherein the drywall compound applicator further comprises a squeegee attached with at least one edge adapted for use on one of corners or a flat surface.

11. The hybrid system of claim 1, wherein said texture applicator subsystem further comprises the texture applicator for allowing application of spray texture via a flexible hose interconnecting the texture applicator and pressurized texture compound from said tank, and wherein said texture applicator subsystem further comprises a trigger for independently controlling flow of texture compound through said texture applicator subsystem.

12. The hybrid system of claim 1, wherein said tank further comprises straps and a waist belt for attaching said tank as a backpack to a user's back.

13. A portable, stable flow, multi-use, hybrid system for application of any material of drywall compound material, paint material, and texture material by the hybrid system, comprising:
A pressurizable hollow tank having a sealable, openable opening adapted for insertion of material comprised of any one of drywall compound, paint, and texture compound, said tank further comprising a first outlet port for pressurized expulsion of the material being used at a given time, said tank further communicating with at least one other outlet port for simultaneous expulsion of material being used at the given time via the at least one other outlet port;
A manual pump air compressor adapted for pressurizing at least a portion of the material supplied from said tank at a given time;
A diaphragm pump attached to said tank adapted for providing simultaneous expulsion of material being used at a given time in said tank via the at least one other outlet port;
An electric air compressor adapted for pressurizing at least another portion of the material supplied from said tank at a given time;
At least one paint roller subsystem optionally detachably attachable to one of the first outlet port and the another outlet port, adapted for pressurized application of paint supplied from said tank to a surface via a paint roller;
At least one paint sprayer subsystem optionally detachably attachable to one of the first outlet port and the another outlet port, adapted for pressurized application of paint from said tank to a surface via a paint sprayer;
At least one drywall compound applicator subsystem optionally detachably attachable to one of the first outlet port and the another outlet port, adapted for pressurized application of drywall compound from said tank to a surface via a drywall compound applicator;
At least one texture applicator subsystem optionally detachably attachable to one of the first outlet port and the another outlet port, adapted for pressurized application of texture compound to a surface via a texture applicator; and
An edge-cutting porous paint pad subsystem optionally detachably attachable to one of the first outlet port and the another outlet port, adapted for pressurized application of paint to a surface via an edge-cutting porous paint pad.

14. The hybrid system of claim 13, wherein the second outlet port is adapted for simultaneous use of the system by a plurality of users, such that the plurality of users may simultaneously use the system to apply one of drywall compound, paint, and texture, whichever material happens to be loaded into the tank at a given time, wherein upon another time loading the system with another one of drywall compound, paint, and texture, the system is likewise capable of supplying such another one of material to a plurality of users, and depending upon which of said paint roll subsystem, said paint sprayer subsystem, said drywall compound applicator subsystem, said texture applicator subsystem, and said edge-cutting porous paint pad subsystem is optionally detachably attached to said tank.

15. The hybrid system of claim 14, wherein upon using the system for painting, one user may use one of said paint roller subsystem, said paint sprayer subsystem, and said edge-cutting porous paint pad subsystem, simultaneously while another user may use another of said paint roller subsystem, said paint sprayer subsystem, and said edge-cutting porous paint pad subsystem.

16. The hybrid system of claim 13, wherein said paint roller subsystem comprises a pole with the paint roller attached to an end of said pole, for allowing application of paint via a flexible hose interconnecting the paint roller and pressurized paint from said tank, and wherein said paint roller subsystem further comprises a trigger for independently controlling flow of paint through said paint roller subsystem.

17. The hybrid system of claim 13, wherein said paint sprayer subsystem comprises the paint sprayer for allowing application of paint via a flexible hose interconnecting the paint sprayer and pressurized paint from said tank, and wherein said paint sprayer subsystem further comprises a trigger for independently controlling flow of paint through said paint sprayer subsystem.

18. The hybrid system of claim 13, wherein said edge-cutting porous paint pad subsystem comprises a pole with the edge-cutting porous paint pad attached to an end of said pole, for allowing application of paint via a flexible hose interconnecting the edge-cutting porous paint pad and pressurized paint from said tank, and wherein said edge-cutting porous paint pad subsystem further comprises a trigger for independently controlling flow of paint through said edge-cutting porous paint-pad subsystem.

19. The hybrid system of claim 13, wherein said drywall compound applicator subsystem further comprises a pole with the drywall compound applicator attached to an end of said pole, for allowing application of drywall compound via a flexible hose interconnecting said drywall compound applicator and pressurized drywall compound from said tank, and wherein said drywall compound applicator subsystem further comprises a trigger for independently controlling flow of drywall compound through said drywall compound applicator subsystem.

20. The hybrid system of claim 13, wherein said texture applicator subsystem further comprises the texture spray applicator for allowing application of spray texture via a flexible hose interconnecting the texture spray applicator and pressurized texture compound from said tank, and wherein said texture applicator subsystem further comprises a trigger for independently controlling flow of texture compound through said texture applicator subsystem.
